(19) United States
(12) Patent Application Publication
(10) Pub. No.: US 2003/0133368 A1
(43) Pub. Date: Jul. 17, 2003

(54) Program, recording medium, information recording device, and information recording method

(76) Inventors: Hiroshi Gotoh, Yokohama-shi (JP); Yasushi Okada, Hadano-shi (JP)

Correspondence Address: DICKSTEIN SHAPIRO MORIN & OSHINSKY LLP, 2101 L STREET NW, WASHINGTON, DC, 20037-1526, US

(21) Appl. No.: 10/317,072

(22) Filed: Dec. 12, 2002

(30) Foreign Application Priority Data
Dec. 13, 2001 (JP) JP2001-379991
Mar. 18, 2002 (JP) JP2002-074594
Sep. 3, 2002 (JP) JP2002-257686
Oct. 7, 2002 (JP) JP2002-293641

(51) Int. Cl. G11B 11/00

(52) U.S. Cl. 369/13.56

(57) ABSTRACT

An information recording program, device, media and method are provided. The disclosure comprises a selection receiving procedure for receiving the selection of an output file; a moving picture creating procedure for converting the output file into moving picture format data, by which contents of the output file is displayed per page when the output file selected in the selection receiving procedure is a document file or an image file; and a recording procedure for recording the moving picture format data, which is converted in the moving picture creating procedure, in an information recording medium. Executing these procedures creates the information recording medium, in which the contents of the above output file is recorded by an information recording device. When the output file is a document file, it is recommended to convert the text information included in the document file into audio format data and record it also in the recording procedure. Therefore, information is recorded in such a way that the contents of recorded files can be read out (visualized or made audible) in an environment without a computer.

### CROSS-REFERENCE TO RELATED APPLICATION

This application claims the priority benefit of Japanese applications serial no.

2001-379991, filed on Dec. 13, 2001

2002-074594, filed on Mar. 18, 2002.

2002-257686, filed on Sep. 3, 2002

2002-293641, filed on Oct. 7, 2002

### BACKGROUND OF THE INVENTION

1. Field of the Invention

This invention relates to a program for a computer to execute a procedure for recording an output file selected by a user in an information recording medium, a computer-readable recording medium in which the program is recorded, an information recording device for recording the output file selected by the user in the information recording medium, and an information recording method for executing such a recording.

2. Description of Related Art:

Printing out on a paper medium by a printer has been a means widely employed for producing documents using an application software running on a computer, such as a word processor, graphic editor, and the like. For printing out, the printer can be driven by a known printer driver, such as the one disclosed in Japanese Laid Open Publication No. He11-119934. In recent years, with paperless movement having been in progress for environmental resource protection, the files processed by applications running on a computer has not been limited to text files, but come to comprise that of sound, still images, and moving pictures. Under these circumstances, recording in an electronic medium (information recording medium) has become in frequent use as a replacing means for printing out on a paper medium.

The known information recording media used for such a recording comprises, optical discs, CD-R (Compact Disc-Recordable), CD-RW (Compact Disc-ReWritable), DVD-R (Digital Versatile Disc-Recordable), DVD-RW (Digital Versatile DiscReWritable), DVD-RAM (Digital Versatile Disc-Random Access Memory), DVD+RW (Digital Versatile Disc+ReWritable), etc. As an example of file output on these media by a computer, it is practiced that a file is formatted to comply with a file system recognizable for the operating system of computer and is recorded, using a known device driver, such as the one disclosed in Japanese Laid Open Publication No. He08-36468. By making the information recording medium used for such a file recording, it becomes possible that more information is recorded in a compact form, compared to the case of printout on a paper medium, that information which cannot be printed out, such as moving pictures, can also be recorded.

The information recording medium in which files are recorded in the above manner, however, requires a user to use a computer to read (visualize) the contents of the recorded files. Besides, the computer needs an application for handling the files. Therefore, the information recording medium has a problem that it lacks portability, a property retained by paper media whose printed out contents can be read anywhere. Currently, the operation by a user of instructing a computer to record (output) is widely different between the case of printout on paper media and that of recording in electronic media. The difference causes another problem that it is difficult to use the recording in information recording media as a replacing means for the printout on paper media.

### SUMMARY OF THE INVENTION

It is an objective of the present invention to solve the aforementioned problems, making it possible to create an information recording medium where information is recorded in such a way that the contents of recorded files can be read out (visualized or made audible) even in an environment devoid of a computer.

It is another objective of the present invention to be able to make an information recording medium by an operation equivalent to outputting to a paper medium.

To achieve at least the above objectives, the present invention provides a program to make a computer execute a selection receiving procedure for receiving user's selection of an output file; a moving picture creation procedure for converting the output file into moving picture format data to display the contents of the output file per page when the output file selected in the procedure is a document file or an image file; and a recording procedure for recording the moving picture format data converted in the procedure in an information recording medium.

In addition, the present invention further provides a program for a computer to execute a selection receiving procedure for receiving user's selection of an output file and the output destination of the output file; a moving picture creating procedure for converting the output file into moving picture format data to display the contents of the output file per page when an information recording medium is selected as the output destination in the procedure and the output file selected by the procedure is a document file or an image file; and a recording procedure for recording the moving picture format data converted in the procedure in the above information recording medium.

In the above program, it is desirable that the above moving picture creating procedure comprises a procedure for creating still image data comprising the print image of each page for a to-be-converted output file; and a procedure for creating data for displaying a plurality of frames of the still data in series when the created each still image data constitutes one frame. It is also desirable that a program is further comprised for a computer to execute a procedure for determining whether the output file selected in the above selection receiving procedure is a moving picture file recording moving picture format data or not; and a procedure for recording the output file directly in the above information recording medium when the computer determines in the procedure that the output file is the moving picture file.

Further, it is desirable that a program is further comprised for a computer to execute a procedure for creating a moving picture searching index for searching the contents of moving pictures created by the above moving picture format data; and a procedure for recording the moving picture searching index created in the procedure in the above information recording medium. It is also desirable that a program is further comprised for a computer, by which, in the above recording procedure, the output file of pre-conversion state is also recorded in the information recording medium when the moving picture format data converted in the above moving picture creating procedure is recorded in the information recording medium.

In addition, the present invention further provides a program for a computer to execute a selection receiving procedure for receiving user's selection of an output file; a moving picture creating procedure for receiving a specified displaying time for each page of said output file to convert contents of said output file into contents of the moving picture format data that are displayed by the displaying time specified by each page, when the selected output file is a document file or an image file; and a recording procedure for recording the moving picture format data converted in the procedure in an information recording medium.

In addition, the present invention further provides a program for a computer to execute a selection receiving procedure for receiving user's selection of an output file; a moving picture creating procedure for converting the output file into moving picture format data to display the contents of the output file per page when the output file selected in the procedure is a document file or an image file; a chapter grouping procedure for setting a chapter grouping for the moving picture format data converted in the procedure so that the display of the above output data per one page or a series of multiple pages are grouped into a chapter; and a recording procedure for recording the moving picture format data, after the chapter grouping setting in the procedure is made, in an information recording medium.

In addition, the present invention further provides a program for a computer to execute a selection receiving procedure for receiving user's selection of an output file and the output destination of said output file; a moving picture creating procedure for receiving a specified displaying time for each page of said output file to convert contents of said output file into contents of the moving picture format data that are displayed by the displaying time specified by each page, when the selected output file is a document file or an image file, when an information recording medium is selected as the output destination in the procedure and the selected output file is a document file or an image file; and a recording procedure for recording the moving picture format data converted in the procedure in the above information recording medium.

In addition, the present invention further provides a program for a computer to execute a selection receiving procedure for receiving user's selection of an output file and the output destination of the output file; a moving picture creating procedure for converting the output file into moving picture format data to display the contents of the output file per page when an information recording medium is selected as the output destination in the procedure and the selected output file is a document file or an image file; a chapter grouping procedure for setting a chapter grouping for the moving picture format data converted in the procedure so that the display of the above mentioned output data per one page or a series of multiple pages are grouped into a chapter; and a recording procedure for recording the moving picture format data, after the chapter grouping setting in the procedure is made, in the above information recording medium.

Further, the present invention provides a program for a computer to execute a selection receiving procedure for receiving user's selection of an output file; a moving picture creating procedure for receiving a specified displaying time for each page of said output file to convert contents of said output file into contents of the moving picture format data that are displayed by the displaying time specified by each page, when the selected output file is a document file or an image file; and a recording procedure for recording, in an information recording medium, the moving picture format data converted in the above moving picture creating procedure and the audio format data converted in the above audio creating procedure.

In addition, the present invention further provides a program for a computer to execute a selection receiving procedure for receiving user's selection of an output file; a moving picture creating procedure for receiving a specified displaying time for each page of said output file to convert contents of said output file into contents of the moving picture format data that are displayed by the displaying time specified by each page, when the selected output file is a document file or an image file; a caption creating procedure for converting the text information contained in the document file into caption data when the above selected output file is the document file; and a recording procedure for recording, in an information recording medium, the moving picture format data converted in the above moving picture creating procedure and the caption data converted in the above caption creating procedure.

In addition, the present invention further provides a program for a computer to execute a selection receiving procedure for receiving user's selection of an output file; a moving picture creating procedure for receiving a specified displaying time for each page of said output file to convert contents of said output file into contents of the moving picture format data that are displayed by the displaying time specified by each page, when the selected output file is a document file or an image file; a first caption creating procedure for converting the text information contained in the document file into caption data when the above selected output file is the document file; a second caption creating procedure for translating the above text file from its source language into another language and converting the translated text information into caption data, a setting display creating procedure for creating data of setting display for selecting a language used in the caption; and a recording procedure for recording, in an information recording medium, the moving picture format data converted in the above moving picture creating procedure, the caption data converted in the above first and second caption creating procedures, and the setting display data created in the above setting display creating procedure.

In addition, the present invention further provides a program for a computer to execute a selection receiving procedure for receiving user's selection of an output file; an audio creating procedure for converting the text information contained in a document file into audio format data when the above selected output file is the document file; and a recording procedure for recording the audio format data converted in the procedure in an information recording medium in a music reproducing format.

In the above programs, it is desirable that a program is further comprised for a computer to execute a procedure for creating an audio searching index for searching the audio contents provided by the above audio format data, and a procedure for recording the audio searching index created in the procedure in the above information recording medium. Further, it is also desirable that the above recording procedure further comprises a procedure for recording also the output file of pre-conversion state in an information recording medium when the audio format data converted in the above audio creating procedure is recorded in the information recording medium. This invention also provides a computer-readable recording medium in which the above program is recorded.

The present invention further provides an information recording device, which comprises a selection receiving means for receiving user's selection of an output file; a moving picture creation means for converting the output file into moving picture format data to display the contents of the output file per page when the output file selected by the means is a document file or an image file; and a recording means for recording the moving picture format data converted by the means in an information recording medium.

The present invention further provides an information recording device, which comprises a selection receiving means for receiving user's selection of an output file and the output destination of the output file; a moving picture creation means for converting the output file into moving picture format data to display the contents of the output file per page when the output destination received as the selection by the means is an information recording medium and the output file received as the selection by the means is a document file or an image file; and a recording means for recording the moving picture format data converted by the means in the above information recording medium.

The present invention further provides an information recording device, which comprises a selection receiving means for receiving user's selection of an output file; a moving picture creation means for receiving a specified displaying time for each page of said output file to convert contents of said output file into contents of the moving picture format data that are displayed by the displaying time specified by each page, when the selected output file received as the selection by the means is a document file or an image file; and a recording means for recording the moving picture format data converted by the means in an information recording medium.

The present invention further provides an information recording device, which comprises a selection receiving means for receiving user's selection of an output file; a moving picture creation means for converting the output file into moving picture format data to display the contents of the output file per page when the output file received as the selection by the means is a document file or an image file; a chapter grouping means for setting a chapter grouping for the moving picture format data converted by the means so that the display of the above mentioned output data per one page or a series of multiple pages are grouped into a chapter; and a recording means for recording the moving picture format data, after the chapter grouping setting by the means is made, in an information recording medium.

The present invention further provides an information recording device, which comprises a selection receiving means for receiving user's selection of an output file and the output destination of the output file; a moving picture creation means for receiving a specified displaying time for each page of said output file to convert contents of said output file into contents of the moving picture format data that are displayed by the displaying time specified by each page, when the output destination received as the selection by the means is an information recording medium and the output file is a document file or an image file; and a recording means for recording the moving picture format data converted by the means in the above information recording medium.

The present invention further provides an information recording device, which comprises a selection receiving means for receiving user's selection of an output file and the output destination of the output file; a moving picture creation means for converting the output file into moving picture format data to display the contents of the output file per page when the output destination received as the selection by the means is an information recording medium and the output file selected by the means is a document file or an image file; a chapter grouping means for setting a chapter grouping for the moving picture format data converted by the means so that the display of the above output data per one page or a series of multiple pages are grouped into a chapter; and a recording means for recording the moving picture format data, after the chapter grouping setting by the means is made, in the above information recording medium.

The present invention further provides an information recording device, which comprises a selection receiving means for receiving user's selection of an output file; a moving picture creation means for receiving a specified displaying time for each page of said output file to convert contents of said output file into contents of the moving picture format data that are displayed by the displaying time specified by each page, when the output file is a document file or an image file;; an audio creation means for converting the text information contained in the document file into audio format data when the above selected output file is the document file; and a recording means for recording, in an information recording medium, the moving picture format data converted by the above moving picture creation means and the audio format data converted by the above audio creation mean.

The present invention further provides an information recording device, which comprises a selection receiving means for receiving user's selection of an output file; a moving picture creating procedure for receiving a specified displaying time for each page of said output file to convert contents of said output file into contents of the moving picture format data that are displayed by the displaying time specified by each page, when the output file is a document file or an image file; a caption creation means for converting the text information contained in the document file into caption data when the above selected output file is the document file; and a recording means for recording, in an information recording medium, the moving picture format data converted by the above moving picture creation means and the caption data converted by the above caption creation mean.

The present invention further provides an information recording device, which comprises a selection receiving means for receiving user's selection of an output file; a moving picture creation means for receiving a specified displaying time for each page of said output file to convert contents of said output file into contents of the moving picture format data that are displayed by the displaying time specified by each page, when the output file is a document file or an image file; a first caption creation means for converting the text information contained in the document file into caption data when the above selected output file is the document file; a second caption creation means for translating the above document file from its source language into another language and converting the translated text information into caption data; a setting display creation means for creating data of setting display for selecting a language used in the caption, and a recording means for recording, in an information recording medium, the moving picture format data converted by the above moving picture creation mean, the caption data converted by the above first and second caption creation means; and the setting display data created by the above setting display creation mean.

The present invention further provides an information recording device, which comprises a selection receiving means for receiving user's selection of an output file; an audio creation means for converting the text information included in a document file into audio format data when the above selected output file is the document file; and a recording means for recording the audio format data converted by the means in an information recording medium in a music reproducing format.

The present invention further provides an information recording method, which comprises a selection receiving procedure for receiving user's selection of an output file; a moving picture creating procedure for converting the output file into moving picture format data to display the contents of the output file per page when the output file selected in the procedure is a document file or an image file; and a recording procedure for recording the moving picture format data converted in the procedure in an information recording medium.

The present invention further provides an information recording method, which comprises a selection receiving procedure for receiving user's selection of an output file and the output destination of the output file; a moving picture creating procedure for converting the output file into moving picture format data to display the contents of the output file per page when an information recording medium is selected as the output destination in the procedure and the output file selected in the procedure is a document file or an image file; and a recording procedure for recording the moving picture format data converted in the procedure in the above information recording medium.

The present invention further provides an information recording method, which comprises a selection receiving procedure for receiving user's selection of an output file; a moving picture creating procedure for receiving a specified displaying time for each page of said output file to convert contents of said output file into contents of the moving picture format data that are displayed by the displaying time specified by each page, when the output file is a document file or an image file; and a recording procedure for recording the moving picture format data converted in the procedure in an information recording medium.

The present invention further provides an information recording method, which comprises a selection receiving procedure for receiving user's selection of an output file; a moving picture creating procedure for converting the output file into moving picture format data to display the contents of the output file per page when the output file selected in the procedure is a document file or an image file; a chapter grouping procedure for setting a chapter grouping for the moving picture format data converted in the procedure so that the display of the above mentioned output data per one page or a series of multiple pages are grouped into a chapter; and a recording procedure for recording the moving picture format data, after the chapter grouping setting in the procedure is made, in an information recording medium.

The present invention further provides an information recording method, which comprises a selection receiving procedure for receiving user's selection of an output file and the output destination of the output file; a moving picture creating procedure for receiving a specified displaying time for each page of said output file to convert contents of said output file into contents of the moving picture format data that are displayed by the displaying time specified by each page, when an information recording medium is selected as the output destination in the procedure the output file is a document file or an image file; and a recording procedure for recording the moving picture format data converted in the procedure in the above information recording medium.

The present invention further provides an information recording method, which comprises a selection receiving procedure for receiving user's selection of an output file and the output destination of the output file; a moving picture creating procedure for converting the output file into moving picture format data to display the contents of the output file per page when an information recording medium is selected as the output destination in the procedure and the selected output file is a document file or an image file; a chapter grouping procedure for setting a chapter grouping for the moving picture format data converted in the procedure so that the display of the above output data per one page or a series of multiple pages are grouped into a chapter; and a recording procedure for recording the moving picture format data, after the chapter grouping setting in the procedure is made, in the above information recording medium.

The present invention further provides an information recording method, which comprises a selection receiving procedure for receiving user's selection of an output file; a moving picture creating procedure for receiving a specified displaying time for each page of said output file to convert contents of said output file into contents of the moving picture format data that are displayed by the displaying time specified by each page, when the output file is a document file or an image file; an audio creating procedure for converting the text information contained in the document file into an audio format data when the above selected output file is the document file; and a recording procedure for recording, in an information recording medium, the moving picture format data converted in the above moving picture creating procedure and the audio format data converted in the above audio creating procedure.

The present invention further provides an information recording method, which comprises a selection receiving procedure for receiving user's selection of an output file; a moving picture creating procedure for receiving a specified displaying time for each page of said output file to convert contents of said output file into contents of the moving picture format data that are displayed by the displaying time specified by each page, when the output file is a document file or an image file; a caption creating procedure for converting the text information contained in the document file into caption data when the above selected output file is the document file; and a recording procedure for recording the moving picture format data converted in the above moving picture creating procedure and the caption data converted in the above caption creating procedure in an information recording medium.

The present invention further provides an information recording method, which comprises a selection receiving procedure for receiving user's selection of an output file; a moving picture creating procedure for receiving a specified displaying time for each page of said output file to convert contents of said output file into contents of the moving picture format data that are displayed by the displaying time specified by each page, when the output file is a document file or an image file; a first caption creating procedure for converting the text information contained in the document file into caption data when the above selected output file is the document file; a second caption creating procedure for translating the above text file from its source language into another language and converting the translated text information into caption data; a setting display creating procedure for creating data of setting display for selecting a language used in the caption; and a recording procedure for recording, in an information recording medium, the moving picture format data converted in the above moving picture creating procedure, the caption data converted in the above first and second caption creating procedures; and the setting display data created in the above setting display creating procedure.

The present invention further provides an information recording method, which comprises a selection receiving procedure for receiving user's selection of an output file; an audio creating procedure for converting the text information contained in the document file into audio format data when the above selected output file is the document file; and a recording procedure for recording the audio format data converted in the procedure in an information recording medium in a music reproducing format.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings in which:

FIG. 1 is a flow chart showing the procedure of processes, which make a computer to execute the program, according to the first embodiment;

FIG. 2 is a figure showing the constitution of the above program;

FIG. 3 is a figure showing a constitutional example of the invented information recording device having the computer for executing the above program;

FIG. 4 is a figure for describing the conversion process, by which a document file, which is under process by the above program, is converted into moving picture format data;

FIG. 5 is a flow chart showing the procedure of processes, which the computer executes by the program according to the second embodiment;

FIG. 6 is a flow chart showing the procedure of processes, which the computer executes by the program according to the third embodiment;

FIG. 7 is a figure for describing the conversion process, by which a document file, which is under process by the program for the third embodiment, is converted into moving picture format data;

FIG. 8 is a flow chart showing the procedure of processes, which the computer executes by the program for the fourth embodiment;

FIG. 9 is a figure for describing the chapter grouping process on the moving picture format data under process by the program according to the fourth embodiment;

FIG. 10 is a flow chart showing the procedure of processes, which the computer executes by the program according to the fifth embodiment;

FIG. 11 is a flow chart showing the procedure of processes, which the computer executes by the program according to the sixth embodiment;

FIG. 12 is a flow chart showing the procedure following the procedure shown in FIG. 11;

FIG. 13 is a figure showing the constitution of the program for the sixth embodiment;

FIG. 14 is a flow chart showing the procedure of processes, which the computer executes by the program for the seventh embodiment;

FIG. 15 is a figure showing the constitution of the program for the seventh embodiment;

FIG. 16 is a block diagram showing the constitution of the DVD+RW drive constituting the information recording device illustrated in FIG. 3; and

FIG. 17 is a block diagram showing the constitution of the PC.

### DESCRIPTION OF THE PREFERRED EMBODIMENT

Hereinafter, with reference to the drawings, the preferred embodiments of this invention are described.

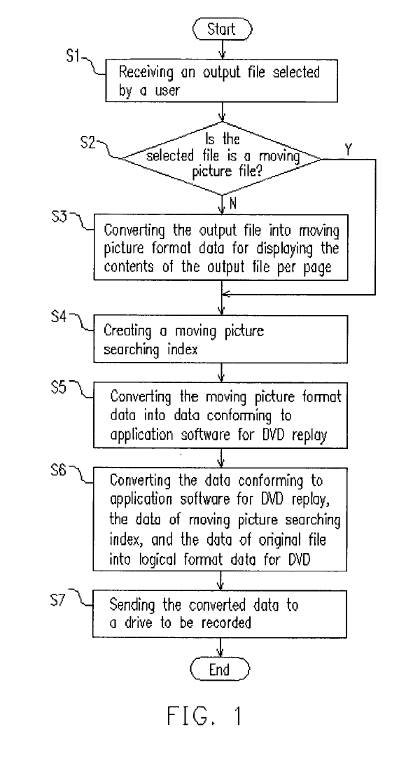

First Embodiment: FIGS. 1 to 4, and 16-17

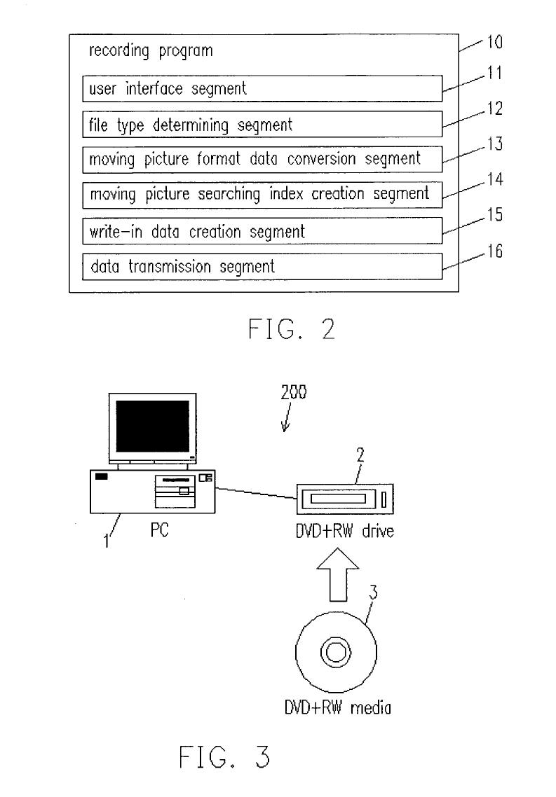

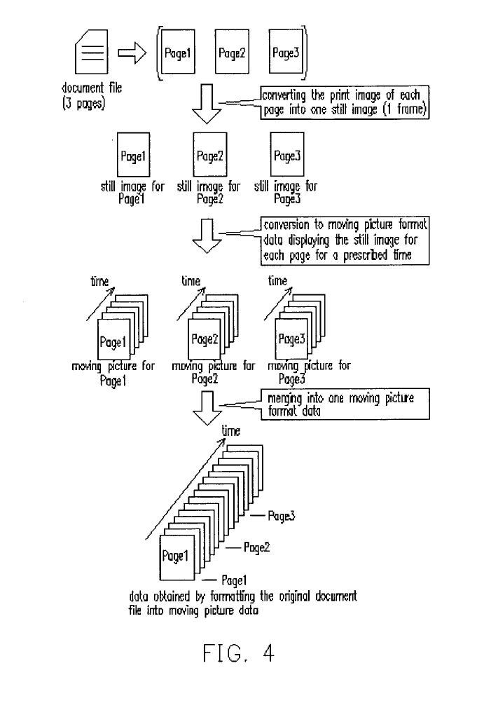

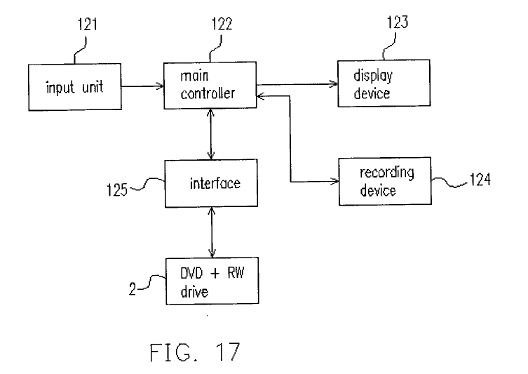

The first embodiment of the program, information recording device, and information recording method is first described according to the present invention. FIG. 1 is a flow chart showing the procedure, which a computer executes by the program. FIG. 2 is a figure showing the constitution of the program. FIG. 3 is a figure showing an example of the constitution of the information recording device having the computer executing the program. FIG. 4 is a figure describing a process by the program, in which a document file is converted into moving picture format data. FIG. 16 is a block diagram showing the constitution of a DVD+RW drive included in the information recording device indicated in FIG. 3. FIG. 17 is a block diagram showing the constitution of a PC.

The program for this embodiment is a recording program, by which a computer, such as a personal computer (PC), operates as respective means described below and executes procedures relating to the information recording method for this embodiment comprising respective procedures described below. Here, the process executed by the program is described by citing an example showing the operation that a disc-shape DVD+RW media 3, which is an information recording media, carries out recording by the information recording device 200 comprising the PC 1 and the DVD+RW drive 2 connected to the PC 1, as shown in FIG. 3. The DVD+RW drive 2 may be connected to the PC 1 via a network.

The hardware configuration of the information recording device for this embodiment is described below. The information recording device mentioned above comprises the PC 1 and the DVD+RW drive 2 connected to the PC 1, wherein the PC 1 controls the operation of the DVD+RW drive 2, recording and reproducing information in and from the disc-shape DVD+RW media 3. The constitution of the DVD+RW drive 2 is shown in FIG. 16. The DVD+RW drive 2 comprises a spindle motor 202, an optical pickup 203, a motor driver 204, a lead amplifier 205, a servo means 206, a DVD decoder 207, an ADIP decoder 208, a laser controller 209, a DVD encoder 210, a DVD-ROM encoder 211, a buffer RAM 212, a buffer manager 213, a DVD-ROM decoder 214, an interface 215, a D/A converter 216, a ROM 217, a CPU 218, and a RAM 219. In FIG. 16, LB represents laser beam, and Audio represents an audio output signal.

Also in FIG. 16, the arrows show the directions in which data flows and control lines coming out from the CPU 218 to reach each component for control are not illustrated in order to simplify the drawing. The ROM 217 stores a controlling program described with codes readable for the CPU 218. When the power source for the DVD+RW drive 2 is turned on, the program stored in the ROM 217 is loaded into a main memory, which is not illustrated. According to the program, the CPU 218 controls the operation of the above each component and sends necessary data for control to the RAM 219 for temporal storage.

The constitution and operation of the DVD+RW drive 2, which is under control of the CPU 218, is as follows. The DVD+RW media 3 is rotated by the spindle motor 202 that is controlled by the motor driver 204 and the servo means 206, so that the linear velocity and angular velocity of the spindle motor is kept constant. Both of the velocities can be changed stepwise. The optical pickup 203 comprises a semiconductor laser, an optical system, a focus actuator, a track actuator, a light receiving element, and a position sensor, all of which are not illustrated, and emits the laser beam LB on the DVD+RW media 3. The optical pickup 203 can be moved in the sledging direction by a seek motor. Theses focus actuator, track actuator, and seek motor are controlled by the motor driver 204 and servo means 206, according to a signal obtained from the light receiving element and position sensor, so that the spot for the laser beam LB emission on the DVD+RW media 3 is determined in the aimed position.

Upon reproducing (read), a reproducing signal obtained by the optical pickup 203 is amplified by the lead amplifier 205 and is digitized, then is input in the DVD decoder 207. The input digitized data is subjected to 8/16 demodulating process in the DVD decoder 207. In this embodiment, recording data is modulated per 8 bits segment (8/16 modulation), where 8 bits is converted into 16 bits. In this case, coupling bits are added so that each average of the number of “1” and “0” included in the original 8 bits segment is equal to that included in the modulated 16 bits segment. This process is called “suppressing DC element”, by which the slice level fluctuation of a DC-cut reproducing signal is suppressed.

The demodulated data is subjected to de-interleaving and error correcting processes. Next, the data is input in the DVD-ROM decoder 214, where the data is further processed for error correction to enhance the credibility of the data. After having undergone error correction process twice, the data is temporarily stored in the buffer RAM 212 by the buffer manager 213. Then, the data, which is arranged as a sector data, is directly transmitted to the PC 1 working as a host computer via the interface 215 such as ATAPI (Attachment Packet Interface) or SCSI (Small Computer System Interface). In the case of audio data, the data output from the DVD decoder 207 is input in the D/A converter 216, and is taken out as the Audio, which is an analog audio output signal.

Upon recording (write), data is sent from the PC 1 via the interface 215 to be temporarily stored in the buffer RAM 212 by the buffer manager 213, then, a light operation starts. In this case, however, the laser spot must be positioned first at the starting point for writing-in. The starting point is obtained by a wobble signal grooved beforehand by meandering tracks on the DVD+RW media 3. The wobble signal contains address information called ADIP (ADDress In Pre-groove), which is taken out by the ADIP decoder 208. Meanwhile, a synchronous signal generated by the ADIP decoder 208 is input in the DVD encoder 210, enabling data to be written in precise position on the DVD+RW media 3. The data stored in the buffer RAM 212 is input in the DVDROM encoder 211 and DVD encoder 210, where error correction codes are added to the data and it is interleaved, then is recorded in the DVD+RW media 3 via the laser controller 209 and the optical pickup 203.

The constitution of the PC 1 connected to the DVD+RW drive 2 described above is shown in FIG. 17. The PC 1 comprises an input unit 121, a main controller 122, a display unit 123, a recording unit 124, and an interface 125. The main controller 121 comprises a microcomputer having a CPU and a main memory (both the components are not illustrated), controlling the whole operation of the PC 1. The main controller 121 also executes respective programs recorded in the recording unit 124 and the like, operating as respective means described later.

The interface 125 is a communication interface interacting with the DVD+RW drive 2, responding to the interface 215 of the DVD+RW drive 2, and is conformity with a standard interface, such as ATAPI or SCSI, wherein the interface 125 is connected to the interface 215 of the DVD+RW drive 2. As for the connection method between both the interfaces, cable connection employing a connection line, such as a connection cable (for example, SCSI cable), is not an only option. Wireless connection using infrared is also applicable.

The recording unit 124 comprises a hard disc drive (HHD) and other components, storing a program written with the codes which can be decoded by the microcomputer of the main controller 122. While the program comprises a program 10 described later, it is not essential for the program to be memorized in the PC 1. When the drive power source of the PC 1 is turned on, a necessary program is loaded into the main memory of the main controller. The display unit 123 has, for example, a CRT (Cathode Ray Tube), a liquid crystal display (LCD), a plasma display panel (PDP), or the like, displaying a variety of information according to the control by the main controller 122.

The input unit 121 has at least one input medium either of, for example, a keyboard, a mouse, a pointing device, etc., receiving an operation or instruction from a user, and notifying the information of them to the main controller. It is also applicable that the information from the input medium is input by a wireless method, or that a unit formed by combining the display unit 123 and input unit 121 is employed, such as a touch-panel-attached CRT. The PC 1 is equipped with an operating system (OS), which controls all the devices constituting the PC 1.

Next, the program for this embodiment is described. The recording program 10 for this embodiment, as shown in FIG. 2, comprises a user interface segment 11, a file type determining segment 12, a moving picture format data conversion segment 13, a moving picture searching index creation segment 14, a write-in data creation segment 15, and a data transmission segment 16. This recording program is a device driver program for the PC 1 to control the DVD+RW drive 2.

When the recording program 10 is activated, the PC 1 starts the operation relating to the information recording method for this embodiment, as represented by the flow chart in FIG. 1. First, at Step S1, the PC 1 executes a selection receiving procedure for receiving the selection of an output file by a user. The user interface segment 11 executes this process. In the above procedure, a graphical user interface (GUI) is displayed so that the user selects a file which the user want to record in the DVD+RW media 3. The selection can be made by allowing the user to make the selection from output-enable documents (files), which are displayed in a tree pattern or a list pattern, or from documents displayed as icons, from which the selected one is dragged and dropped by the user operating a mouse. The files which can be selected to be recorded in the DVD+RW media 3 comprise document files recording data of character, table, drawing, etc., image files recording image data, and moving picture files recording moving picture format data. In this selection receiving procedure, the main controller 122 of the PC 1 operates as the selection receiving mean.

Next, at Step S2, it is determined that whether the selected output file is a moving picture file recording moving picture format data. The determination can be made by checking if the extension of the selected file coincides with the one pre-registered as the extension of moving picture file or not, such as “avi” or “mpg.” This process is executed by the file type determining segment 12. When the file turns out not be a moving picture file at Step S2, that is to say, it is either a document file or an image file, the program proceeds to Step S3, where the output file is converted into moving picture format data by which the contents of the file is displayed per page. As the moving picture format, for example, MPEG (Moving Picture Experts Group) 2 can be employed. The moving picture format data conversion segment 13 executes the above process.

Here, the method for converting the output data into moving picture format data is described. When the contents of document or image file is printed out with a printer and the like, the printout is carried out for each portion of the contents as a page. FIG. 4 shows the example of converting 3 pages of document file into moving picture format data. The print image for per page printout is converted into a still image (one frame) constituting the portion of a moving picture. This one frame covers the portion of the moving picture, for example, displayed for 1/30 second, so that the data is formed in such a way that it allows the still image of each page to be displayed as a plurality of frames in series, meaning the still images are on display for a certain duration. Then, the formed data is merged (joined) to form a set of moving picture format data. Thus, the original document file can be converted into the moving picture format data by which the contents of the file is displayed per page for a certain time. The time for displaying the contents is either preset, or set by a user upon his or her file selection. The above processes of Step S2 and Step S3 are the processes for a moving picture creating procedure. In the moving picture creating procedure, the main controller 122 operates as the moving picture creation mean.

When the process at Step S3 is finished or the selected file is determined as a moving picture format file at Step S2, the program proceeds to Step S4, where the procedure for creating a moving picture searching index is carried out. With this index, the contents of moving picture is searched, the moving picture being formed by the moving picture format data created at Step S3 or selected at Step S1. This process is executed by the moving picture searching index creation segment 14. The data of moving picture searching index can be created as post-attached dynamic index information, according to, for example, MPEG7 standard. Also, it is applicable that the moving picture searching index is created automatically, or according to the instruction of a user after it is received upon displaying GUI. For automatic creation, for example, for creating the index on the data formed by the conversion at Step S3, it is recommended that event data allowing the display content to change in the position of page shift is added to the index data, and it is registered as such data.

Next, at Step S5, the moving picture format data, which is selected as the output file or formed by the conversion at Step S3, is converted into data with a format conforming to applications for reproducing DVD (reproduced by a DVD reproducing unit). As such a format, for example, DVD-Video format can be employed.

Then, at Step S6, the data created at Step S5, the moving picture searching index data formed at step S4, and the data of output file selected at Step S1 are converted into logical format data to be written in on the DVD+RW media 3. As this logical format data, for example, UDF (Universal Disc Format) Ver. 1.02 format can be employed. The output file to be converted by this process is the original data, retaining the state before the conversion into moving picture data at Step S3. The above Steps S5, S6 are the processes executed by the write-in data creation segment 15.

Afterward, at Step S7, the data formed by the conversion at Step S6 are sent to the DVD+RW drive 2, which is driven to write in the data on the DVD+RW media 3 to finish the whole Steps. The data transmission segment 16 assumes the execution of this process, and the processes at Steps S5, S7 are included in the recording procedure. In the recording procedure, the main controller 122 and DVD+RW drive 2 operate as the recording means.

Therefore, the recording program 10 can make the PC 1 execute the process that, when the output file selected by a user is a document file or an image file, the output file is recorded in the DVD+RW media 3 as the moving picture data whose contents are displayed per page for a certain time. The information recording device for this embodiment can records the file selected by a user in the way described above, by executing the information recording method for this embodiment. Since the moving picture data mentioned above is recorded in the format that can be applicable to a reproduction using a DVD reproducing unit for commercial use, the DVD+RW media 3 having the data created by the above processes can be reproduced by the DVD reproducing unit in an environment without a computer, such as the PC 1, and the recorded contents can be visualized by displaying it on a proper display device, such as a television receiver.

When the output file is a moving picture format file, the file is recorded after having been converted into data with the format that can be reproduced by the DVD reproducing unit for commercial use, so that the contents of the file can be also reproduced by the DVD reproducing unit and is visualized. Since the moving picture searching index is also recorded with the formatted data, searching per page using the index is possible if the DVD reproducing unit is equipped with an interpreting mechanism for the index. Therefore, by using this program, an information recording medium with a high portability, making it possible to visualize the contents of the information recording medium without a computer, can be created by a computer. Also, by using the information recording medium or information recording method for this embodiment, a similar information recording medium with a high portability can be created.

Likewise, the output file of pre-conversion state is also recorded, so that it is possible for a user to access the original output file and edit it when the user is provided with a computer having a means for reading data out from the information recording medium and an application software handling the output file. In the above described embodiment, the creation and recording of the moving picture searching index and recording of the pre-conversion output file data are not imperative, which are procedures that can be omitted. The method of creating moving format data from a document file or an image file is indicated as one example, so that another method can be employed.

It is also possible that a plurality of output files are recorded in the above procedures in a proper order or user-specified order when they are selected at once, and only a user-preferred portion of them can also be recorded. What is described above is an example that the selected output file is output on a specific DVD+RW drive, but the file can be output on an optional drive selected out of a plurality of drives. Naturally, using a drive other than that of DVD+RW specification can be another option, in which information is recorded in an information recording medium conforming to the drive.

As for write-enable DVDs other than the DVD+RW mentioned above, there are one-time write-enable DVDs (also called DVD Write Once), such as DVD-RAM-WO (:Write Once), DVD-R, and DVD+R, and multiple-time write-enable DVDs, such as DVD-RAM and DVD-RW. It is also applicable to employ drives or information recording media conforming to these types of DVD. The constitution of such drives is almost equal to the one shown in FIG. 16, but the land pre-pit or pre-pit method is employed, instead of the wobble signal method, for some types of DVDs. Other types of DVDs are also usable and the recording method for them is not limited to the one readable for a DVD reproducing units. The recording method can be the one readable for a reproducing unit other than the DVD reproducing unit, such as CDV (Compact Disc Video). Further, the above description is made by citing the example that the information recording device 200 comprises the PC 1 and DVD+RW drive 2, both are separately arranged. However, it is also applicable to this embodiment when a computer and a drive are integrally configured. Also, an information recording device for implementing the information recording method for this embodiment is not limited to the information recording device having the constitution described above.

The program described in this embodiment may be pre-stored in memory means, such as ROM or hard disc, included in the PC 1 shown in FIG. 3, but may also be recorded in such a recording medium as CD-ROM, or in a nonvolatile recording medium (memory), such as flexible disc, SRAM, EEPROM, or memory card, for application. The before mentioned procedures are carried out by installing the program stored in such a memory in a computer and make its CPU execute the program, or make the CPU read out the program from the memory and execute it. When a computer is connected to a network, the program can be downloaded from an external apparatus having a recording medium storing the program or from an apparatus whose memory means storing the program, and is executed.

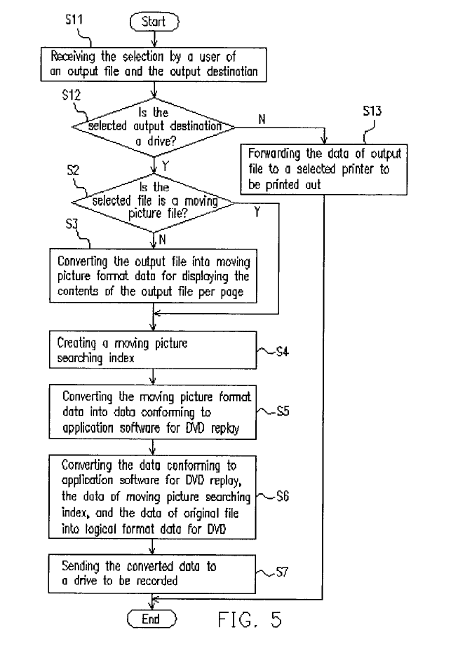

Second Embodiment: FIG. 5

Next to be described, using FIG. 5, is the second embodiment of the program, information recording device, and information recording method, all of which are disclosed in this invention. FIG. 5 is a flow chart, which shows the procedure of processes a computer executes by the program. This program is part of an application program for editing document files, image files, moving picture files, etc., and the program makes a computer executes the process for outputting the files created by the application program or the files under editing process. By this program, the computer, such as a personal computer (PC), operates as respective means described below and executes processes relating to the information recording method for this embodiment comprising respective procedures described below.

Same as the case of the first embodiment, the information recording device for this embodiment comprises the PC 1 and the DVD+RW drive 2 connected to the PC 1, as shown in FIG. 2, executing the recording and reproducing of information using the disc-shape DVD+RW media 3. The hardware configuration of this information recording device is equal to the one described in the first embodiment, so that the explanation for the configuration is omitted. In this embodiment, the information recording device 200 has means with functions different from that of the information recording device described in the first embodiment, operating not as the same, due to the difference of the program to be executed, but characters used for the description here are the same one used in the first embodiment. Accordingly, in the following embodiments, the same characters are used for description unless a particular remark for character change is made. In this description, following the case of the first embodiment, the example is cited that the information recording device 200, as shown in FIG. 3, operates to make the disc-shape DVD-RW media 3 execute recording, and the processes to be executed by this program is described. The constitution of this program is same as the recording program 10 related in the first embodiment.

When the file output is selected in the application program containing this program, the program starts, activating the PC 1 constituting the information recording device 200 so that the PC 1 executes the operation related to the information recording method for this embodiment represented by the flow chart in FIG. 5. First, at Step S11, the PC 1 executes a selection receiving procedure for receiving user's selection of an output file and the output destination of the output file. The user interface segment 11 assumes the execution of this process.

The selection of output file can be set as an automatic operation, for example, by allowing a file under editing process to be selected automatically. As the output destination, it is selectable that the file is output either on the DVD+RW media 3, i.e., output is made by the DVD+RW drive 2, or on a paper medium, i.e., printout is made by a printer (not shown). Receiving the selection, as mentioned above, can be done, for example, by displaying GUI and prompting a user to input. In this selection receiving procedure, the main controller 122 of the PC 1 operates as the selection receiving mean.

Next, at Step S12, it is determined that whether the selected output destination is a drive for writing in on an information recording medium, or not. If it is the drive, the processes after Step S2 follow, of which the description is left out since the processes are the same one related in the first embodiment, using FIG. 1. In this embodiment, however, the process at Step S12 is also included in the moving picture creating procedure. When the output destination is not the driver (when it is the printer), the program proceeds to step 13, where the print image data of output file is created, the image data is transmitted to the selected printer, and the contents of output file is printed out to end the whole Steps. The process at Step S13 is executed by starting an independent printer driver program.

According to the above program, the contents of file can be recorded in the information recording medium as the formatted moving picture data that can be reproduced by a DVD reproducing unit even in an environment without a computer, such as PC, and the required operation is equivalent to that for the output on paper media. Also, according to the information recording device for this embodiment, the contents of file can be recorded as described above by executing the information recording method for this embodiment. Therefore, by using such a program, information recording device, and information recording method, recording in and outputting from the information recording medium can be easily utilized as a replacing means for the printout on paper media. The modification mentioned in the first embodiment can be also applied to the above program, information recording device, and information recording method.

In this description, the above program is explained as part of an application program. However, it is possible that the program is prepared as a device driver program for driving a recording device (herein referred to the DVD+RW drive 2) executing the recording on the information recording medium. In such a case, the function of the operating system or application program is used for receiving the selection of the output file or output destination. Therefore, when the recording device is selected as the output destination, the program receives the result of recording device selection, together with a print (information recording) command, in the process of selection receiving procedure. It is also applicable that, as in the case of the first embodiment, the PC 1 displays the graphical user interface (GUI), allowing a user to select the file to be output and its output destination in the selection receiving procedure, upon starting the program.

The program described in this embodiment may be pre-stored in a memory mean, such as ROM or hard disc, included in the PC 1 shown in FIG. 3, but may also be recorded in a nonvolatile recording medium (memory), as in the case of the first embodiment. The before mentioned procedures are carried out by installing the program stored in such a memory in a computer and make its CPU execute the program, or make the CPU read out the program from the memory and execute it. When a computer is connected to a network, the program can be downloaded from an external apparatus having a recording medium storing the program or from an apparatus whose memory means storing the program, and is executed.

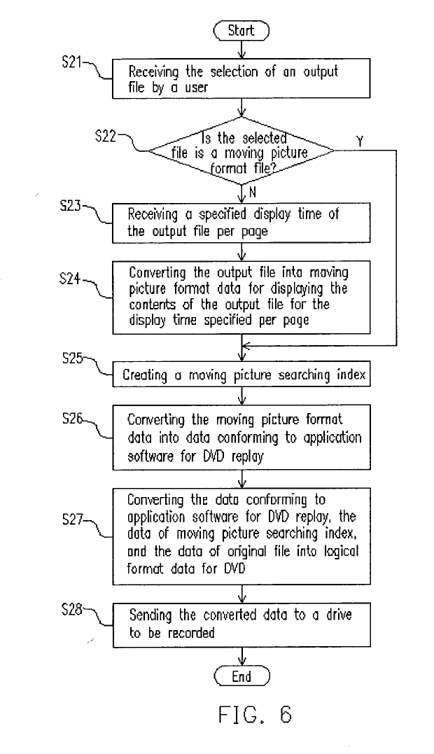

Third Embodiment: FIGS. 5 and 6

Next to be described is the third embodiment of the program, information recording device, and information recording method, all of which are disclosed in this invention. FIG. 5 is a flow chart, which shows the procedure of processes a computer executes by the program. FIG. 6 is a figure describing a process by the program, in which a document file is converted into moving picture format data. The program for this embodiment is a recording program, as the program for the first embodiment, by which a computer, such as a personal computer (PC), operates as respective means described below and executes procedures relating to the information recording method for this embodiment comprising respective procedures described below. The constitution of this program is same as the recording program 10 related in the first embodiment. Therefore, in this description, following the case of the first embodiment, the example is cited that the information recording device 200, as shown in FIG. 3, operates to make the disc-shape DVD-RW media 3 execute recording, and the processes to be executed by this program is described.

When this recording program 10 is activated, the PC 1 comprising the information recording device 200 executes the operation related to the information recording method for this embodiment represented by the flow chart in FIG. 6, and executes first the selection receiving procedure for receiving user's selection of an output file at Step S 21. Since the process at Step S21 is the same one executed at Step S1, as shown in FIG. 1, described in the first embodiment, further explanation is left out. Next, at Step S22, it is determined that whether the selected output file is a moving picture file recording moving picture format data, or not. This determination is carried out by checking if the extension of the selected file coincides with the one pre-registered as the extension of moving picture file or not, such as “avi” or “mpg.” This process is executed by the file type determining segment 12.

When the file turns out not be a moving picture file at Step S22, that is, it is either a document file or an image file, the program proceeds to Step S23, where a specified display time for each page of the output file is received. The user interface segment 11 executes this process. In this process, GUI is displayed for a user to specify the time of displaying the image of each page of the output file selected at Step S21. The user is allowed to specify the time either by entering a specific figure for each page, or by automatically or manually select the figure for specific time from a prescribed template and the like. Next, at Step S24, the output file is converted to moving picture format data, by which the contents of the output file is displayed per page for display time specified at Step S23. As a format for the data, for example, MPEG (Moving Picture Experts Group ) 2 format can be used. The moving picture format data conversion segment 13 executes the above process.

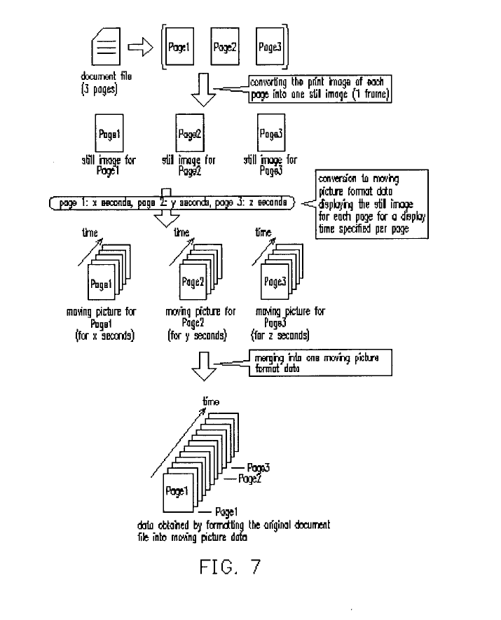

Now, the method of converting the output file to the moving picture format data is described. When the contents of document or image files is printed out with a printer and the like, the printout is made for each portion of the contents as a page. FIG. 7 shows the example of converting 3 pages of document file into moving picture format data. The print image for per page printout is converted into a still image (one frame) constituting the portion of a moving picture. This one frame covers a portion of the moving picture, for example, displayed for 1/30 second, so that the data is formed in such a way that it allows the still image of each page to be displayed for the specified time in series. Then, the formed data is merged (joined) to form a set of moving picture format data. Thus, the original document file can be converted into the moving picture format data by which the contents of the file is displayed per page for the specified time. The above Steps 22, 24 are the processes constituting the moving picture creating procedure. In this moving picture creating procedure, the main controller 122 of the PC 1 operates as the moving picture creation mean.

Following the completion of Step S24 or the selected output file is found as a moving picture format file at Step 22, the program proceeds to Step S25 for creating the moving picture searching index. Ensuing Step S25 and Step S28 constitute the same processes of Step 4 and Step S7 described in the first embodiment, using FIG. 1, so that the description for the processes is omitted.

As described above, the recording program 10 can make the PC 1 execute the process that, when the output file selected by a user is a document file or an image file, the output file is recorded in the DVD+RW media 3 as the moving picture data whose contents are displayed per page for the specified time. The information recording device for this embodiment can records the file selected by a user in the way described above, by executing the information recording method for this embodiment. Since the moving picture data mentioned above is recorded in the format that can be applicable to a reproduction using a DVD reproducing unit for commercial use, the DVD+RW media 3 having the data created by the above processes can be reproduced by the DVD reproducing unit in an environment without a computer, such as the PC 1, and the recorded contents can be visualized by displaying it on a proper display device, such as a television receiver.

Also, the program 10 for this embodiment brings the same effect achieved by the program, information recording device, and information recording method, which are used in the first embodiment. In addition to that, when the output file to be recorded is a document file or an image file, the display time for each page of the file can be specified, so that an information recording medium for displaying each page for a necessary time according to the usage of the contents can be created. Therefore, the created information recording medium can be utilized in such a case that a presentation is made by spending different time for every page while the recorded contents is reproduced. Thus, the program provides a highly effective utility. The modification, as described in the first embodiment, can also be applied in this embodiment.

The program described in this embodiment may be pre-stored in memory means, such as ROM or hard disc, included in the PC 1 shown in FIG. 3, but may also be recorded, as in the cases of the first and second embodiments, in a nonvolatile recording medium (memory) for application, or can be downloaded from a device connected to the PC 1 via a network.

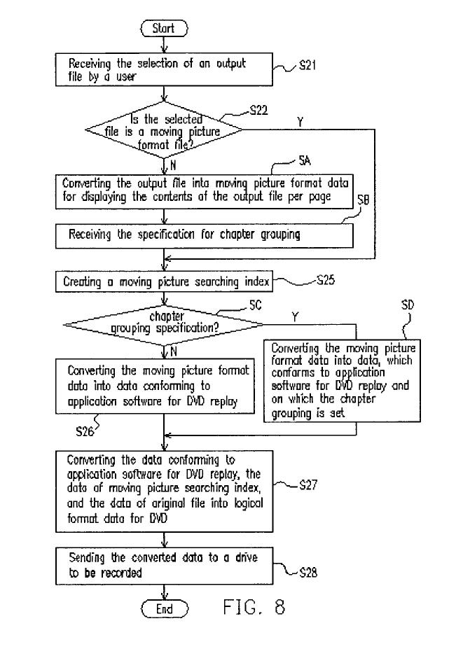

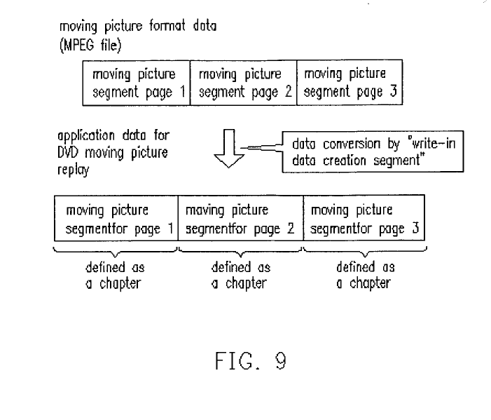

Fourth Embodiment: FIGS. 8 and 9

Next to be described is the fourth embodiment of the program, information recording device, and information recording method, all of which are disclosed in this invention. FIG. 8 is a flow chart, which shows the procedure of processes a computer executes by the program. FIG. 6 is a figure describing the chapter grouping process for moving picture format data under the process by the program. In FIG. 8, the part of processes similar to that shown in the flow chart in FIG. 6 are indicated by giving the same step numbers used in FIG. 6.

The program for this embodiment is also a recording program, by which a computer, such as a personal computer (PC), operates as respective means described below and executes procedures relating to the information recording method for this embodiment comprising respective procedures described below. The constitution of this program is same as the recording program 10 described in the first and third embodiments. Accordingly, as in the case of the first and third embodiments, the process executed by the program is described by citing an example showing the operation that the disc-shape DVD+RW media 3, which is an information recording media, carries out recording by the information recording device 200 as shown in FIG. 3.

When the recording program 10 is activated, the PC 1 constituting the information recording device 200 starts the operation relating to the information recording method for this embodiment, as represented by the flow chart in FIG. 8. The processes executed at Steps S21, S22 are the same one for the third embodiment, of which the processes this program also follows in proceeding to Step S25 when the output file turns out be moving picture file at Step S22. If the output file is not a moving picture file at Step S22, the program proceeds to Step SA, converting the output file into moving picture format data by which the contents of the output file is displayed per page. Since this process is the same one of Step S3 shown in FIG. 1 and described in the first embodiment, detailed description for the process is omitted. The time of displaying the contents of each page can be preset, or set by a user upon his or her file selection.

Following the above conversion process, the program proceeds to Step SB, receiving the specification for chapter grouping. The specification is made for displaying every one page or a continuous, multiple pages. It is applicable that the user is allowed to manually input the point for chapter grouping, or arranges an automatic chapter grouping specification for displaying one page or a prescribed set of pages. The user interface segment 11 (manual specification) or write-in data creation segment 15 (automatic specification) executes the process of Step SB. The chapter grouping is achieved by grouping the moving picture into segments called chapters or parts of title (PTT). Upon reproducing the moving pictures grouped in such a way by a DVD reproducing unit, a user can pinpoint a particular segment for first reproduction by specifying its chapter number.

After the completion of Step SB or a moving picture file is found at Step S22, the moving picture searching index is created at Step 25, as in the case of the first embodiment, and Step SC follows. At Step SC, the determination is made of whether the output file under process has the specification for chapter grouping or not. Since the chapter grouping specification has been executed at Step SB when the output file is a document file or an image file, it is determined that the file contains the specification and Step SD follows.

At Step SD, the moving picture format data created by the conversion at Step SA is converted into the data with a format comforming to an application for reproducing DVD (reproduced by DVD reproducing unit) and the chapter grouping is set on the data, according to the specification made at Step SB, for displaying every single page or multiple pages of the output file. FIG. 9 shows an example of setting the chapter grouping for per page display on moving picture format data obtained by converting 3 pages of document file. As shown in this example, the chapter grouping can be executed by defining each portion of moving picture data for displaying each page as a chapter. As a format for the above moving picture data, for example, DVD-Video format can be employed, and VOB file works in this format as a file for storing images and audio. The process at Step SD constitutes the chapter grouping procedure, in which the main controller 122 of the PC 1 operates as the chapter grouping mean. After completing the process of Step SD, the program proceeds to Step S27.

When the output file is a moving picture file, the process at Step SB is not carried out, and a determination is made at Step SC that the chapter grouping specification is not done, from which Step S26 ensues. At Step S26, as in the case of the first embodiment, the moving picture format data of the output file is converted into the data with a format corresponding to a DVD reproducing application, and Step 27 follows. At Step 27, the data converted at Step 26 or Step SD, the index data created at Step S25, and the data of the output file selected at Step 21 are converted into logical format data for writing in them on the DVD+RW media 3. As for the logical format to be used, it follows the case of the first and third embodiments. The write-in data creation segment 15 executes the above Steps SC, SD, 26 and 27.

Afterward, at Step 28, the data created by the conversion at Step 27 is written in on the DVD+RW media 3, and the program is ended. The data transmission segment 16 executes this process. The processes at Steps 27 and 28 constitute the recording procedure, in which the main controller 122 and DVD+RW drive 2 operates as the recording mean. Therefore, the recording program 10 can make the PC 1 execute the process that, when the output file selected by a user is a document file or an image file, the output file is recorded in the DVD+RW media 3 as the moving picture data, whose contents are displayed per page for the specified time and on which the chapter grouping is set for displaying one page or multiple pages in series. The information recording device for this embodiment can records the file selected by a user in the way described above, by executing the information recording method for this embodiment. The contents of the moving picture data mentioned above can be visualized, using a DVD reproducing unit, by displaying it on a proper display device, such as a television receiver, as in the case of the first embodiment.

Therefore, by using this program, an information recording medium with a high portability, making it possible to visualize the contents of the information recording medium without a computer, can be created by a computer. Also, by using the information recording medium or information recording method for this embodiment, a similar information recording medium with a high portability can be created. Also, the chapter grouping is set when the output file to be recorded is a document file or an image file, so that a particular page or pages corresponding to the contents of the file can be reproduced randomly by specifying the set chapter upon reproducing on a DVD reproducing unit, enabling a user to display a desired page easily. The function of jumping to a specified chapter upon reproducing is a basic function of DVD reproducing units. Therefore, the chapter grouping of grouping moving picture data into chapters enables the randomly specified reproduction mentioned above to be performed on almost every reproducing unit, including the one without an interpreting mechanism for the index, due to the non-conformity to MPEG7 standard. The manual operation of the random reproduction is simple. In regard with this program, effects and modifications other than the aspect of display time, and the utility allowing the program to be recorded in a nonvolatile recording media to be provided, are the same as in the case of the first and third embodiments.

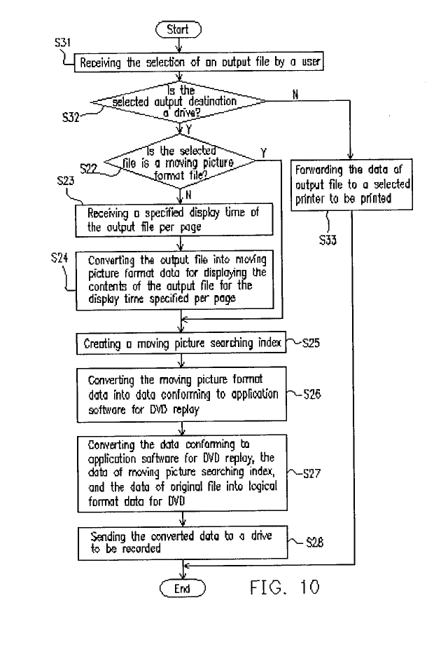

Fifth Embodiment: FIG. 10

Next to be described, using FIG. 10, is the fifth embodiment of the program, information recording device, and information recording method, all of which are disclosed in this invention. FIG. 10 is a flow chart, which shows the procedure of processes a computer executes by the program. Like the program described in the second embodiment, this program is part of an application program for making a computer executes the process for outputting the files created by the application program or the files under editing process. By this program, the computer, such as a personal computer (PC), operates as respective means described below and executes processes relating to the information recording method for this embodiment comprising respective procedures described below.

In this embodiment, as in the case of the first and third embodiments, the process executed by this program is described by citing an example showing the operation that the disc-shape DVD+RW media 3, which is an information recording media, carries out recording by the information recording device 200 as shown in FIG. 3. The constitution of this program is also same with that of the recording program 10 described in the first and third embodiments.

When the file output is selected in the application program containing this program, the program starts, activating the PC 1 comprising the information recording device 200 so that the PC 1 executes the operation related to the information recording method for this embodiment represented by the flow chart in FIG. 10. First, at Step S31, the PC 1 executes the selection receiving procedure for receiving user's selection of an output file and the output destination of the output file. The user interface segment 11 assumes the execution of this process.

The selection of output file can be set as an automatic operation, for example, by allowing a file under editing process to be selected automatically. As the output destination, it is selectable that the file is output either on the DVD+RW media 3, i.e., output is made by the DVD+RW drive 2, or on a paper medium, i.e., printout is made by an unillustrated printer. Receiving the selection, as mentioned above, can be done, for example, by displaying GUI and prompting a user to input. In this selection receiving procedure, the main controller 122 of the PC 1 operates as the selection receiving means.

Next, at Step S32, it is determined that whether the selected output destination is a drive for writing in on an information recording medium, or not. If it is the drive, the processes after Step S22 follow, of which the description is left out since the processes are the same one related in the third embodiment, using FIG. 6. In this embodiment, however, the process at Step S32 is also included in the moving picture creating procedure. When the output destination is not the driver (when it is the printer), the program proceeds to step 33, where the print image data of output file is created, the image data is transmitted to the selected printer, and the contents of output file is printed out to end the whole Steps. The process at Step S33 is executed by starting an independent printer driver program.

According to the above program, the contents of file can be recorded in the information recording medium as the formatted moving picture data that can be reproduced by a DVD reproducing unit even in an environment without a computer, such as PC, and the required operation is equivalent to that for the output on paper media. Also, according to the information recording device for this embodiment, the contents of file can be recorded as described above by executing the information recording method for this embodiment. Therefore, by using such a program, information recording device, and information recording method, recording in and outputting from the information recording medium can be easily utilized as a replacing means for the printout on paper media.

The modification mentioned in the first and third embodiments can be also applied to this program, information recording device, and information recording method. The advantage allowing the program to be recorded in a nonvolatile recording medium to be provided are the same as in the case of the first and third embodiments. As to the processes following Step 22 in this embodiment, it is applicable to execute the processes after Step 22 described, using FIG. 8, in the fourth embodiment, instead of executing the process consisting of the same steps in the third embodiment. As a result, the same effect described in the fourth embodiment can be obtained.

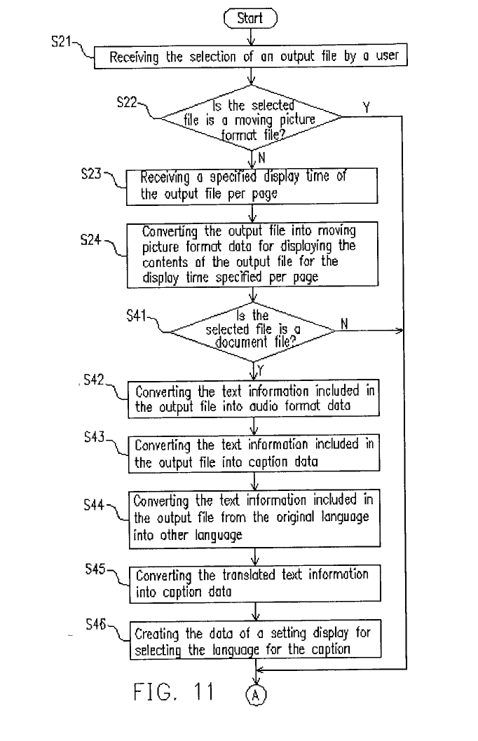

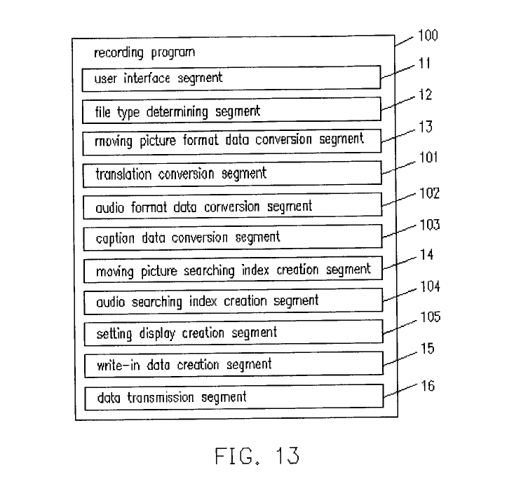

Sixth Embodiment: FIGS. 11 and 13

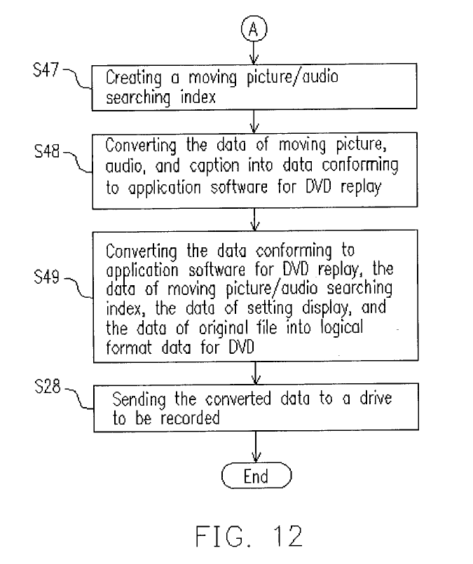

Next to be described is the sixth embodiment of the program, information recording device, and information recording method, all of which are disclosed in this invention. FIG. 11 and FIG. 12 are flow charts showing the procedure of a series of processes, which a computer executes by the program. FIG. 13 is a figure showing the constitution of the program. In the FIG. 11 and FIG. 12, the steps representing the same processes shown in the flow chart in FIG. 6 are given the same step numbers used in FIG. 6. The program for this embodiment is a recording program, as the program for the first embodiment, by which a computer, such as a personal computer (PC), operates as respective means described below and executes procedures relating to the information recording method for this embodiment comprising respective procedures described below. In this description, following the case of the first embodiment, the example is cited that the information recording device 200, as shown in FIG. 3, operates to make the disc-shape DVD-RW media 3 execute recording, and the processes to be executed by this program is described.

This program 100, as shown in FIG. 13, comprises the user interface segment 11, the file type determining segment 12, moving picture format data conversion segment 13, the moving picture searching index creation segment 14, the write-in data creation segment 15, and the data transmission segment 16, all of which are the components of the recording program 10 shown in FIG. 2, wherein the program further comprises a translation conversion segment 101, an audio format data conversion segment 102, a caption data conversion segment 103, an audio searching index creation segment 104, and a setting display creation segment 105. This program 100 is a device driver program for the PC 1 to control the DVD+RW drive 2.

When this recording program 100 is activated, the PC 1 comprising the information recording device 200 starts executing the operation related to the information recording method for this embodiment represented by the flow charts in FIG. 11 and FIG. 12. Since the processes of Steps S21, S24 are the same one described, using FIG. 6, in the third embodiment, further explanation is left out. However, when the output file is identified as a moving picture format file, the process proceeds directly to Step S47 shown in FIG. 12. If the selected output file is not a moving picture file, the process proceeds from Step S22 to Step S23 and to S24, then to Step S41.

It is determined at Step S41 that the selected output file is a document file or not. If the file is not a document file, Step S47 shown in FIG. 12 follows. If the file is a document file, the process proceeds to Step 42, where audio data for reading out text information is made out of the text information included in the output file and is made as audio format data. That is, the text information included in the output file is converted into the audio format data. The audio format data conversion segment 102 executes this process of Step S42, which constitutes the audio creating procedure. As to the creation of audio data, a proper, known audio synthesizing method may be employed. Also, it is applicable to this embodiment that the audio data creation process itself is not included in the processes of this program, wherein this program instructs other application to execute the audio data creation process, obtaining its result. As an audio format, for example, MP3 (MPEG Audio Layer-3) format or Wave format can be employed. The main controller 122 of the PC 1 operates as the audio creation means in the audio creating procedure.

When the process at Step S42 is over, Step S43 follows, at which caption data representing the contents of text information is created, according to the text file information included in the output file. That is, the text information included in the output file is converted into the caption data. As caption data, for example, it is appropriate to create caption format data for displaying captions using a caption display function of a DVD reproducing unit, wherein the contents of text information can be sequentially displayed by changing it per prescribed time. One applicable example of such a caption data format is Text format. The data can be made in either way that a caption consisting of several lines are displayed on the end of a screen, or a caption is displayed on the whole screen. It is also recommendable that marking data is inserted for every caption change point in the caption data for the chapter grouping and searching, so that the captions can be displayed and changed for one screen at a time in order, using the searching function of a DVD reproducing unit.

It is also appropriate for using as caption data to create moving picture data making the lines of text information scroll in a prescribed speed to be displayed. This sort of data is created as the one with such a moving picture format as MPEG 2 and the like. Further, it is applicable to create a plurality of data with a different format, as mentioned above, and to make a free choice upon reproducing one of them. The caption data conversion segment 103 executes the process of above Step S43, which constitutes the first caption creating procedure. The main controller 122 operates as the first caption creation means in this first caption creating procedure.

Next, the program proceeds to Step S44, where the text information contained in the output file is translated from the original language into other one, for example, from Japanese to English or vice versa. The translation conversion segment 101 executes this process. As to the translation process, a proper, known automatic translation method may be employed. Also, it is applicable to this embodiment that the translation process itself is not included in the processes of this program, wherein this program instructs other application to execute the process, obtaining its result. Then, at Step S45, caption data representing the contents of text information is created, according to the translated text information. That is, the translated text information is converted into the caption data. The caption data conversion segment 103 executes this process. The above processes of Step S44 and S45 constitute the second caption creating procedure, in which the main controller 122 operates as the second caption creation mean.

Next, at Step S46, the data of a setting display for a user to select the language of a caption is created. The setting display allows the user to make a decision, utilizing the function of a DVD reproducing unit, on whether to, or not to, display either caption created at Step S43 or S45. The data necessary for that decision is created at this Step S46. The setting display creation segment 105 executes this process of Step S46 constituting the setting display creating procedure, in which the main controller 122 operates as the setting display creation mean. Upon ending the process of Step S46, the program proceeds to Step S47 shown in FIG. 12.

At Step S47 shown in FIG. 12, both the moving picture searching index and the audio searching index are created. The moving picture searching index is used for searching the contents of the moving pictures represented by the data either created at Step S24 or of the moving picture format selected at Step S 21, while the audio searching index is used for searching the contents of the audio represented by the data of audio format created at Step 42. The moving picture searching index creation segment 14 and the audio searching index creation segment 104 execute the above process, respectively.

The moving picture/audio searching data can be created as post-attached dynamic index information, according to, for example, MPEG7 standard. Also, it is applicable that the moving picture/audio index data is created automatically, or according to the instruction of a user after it is received upon displaying GUI. For automatic creation, for example, for creating the indexes on the data formed by the conversion at Step S24, it is recommended that event data allowing the display content to change in the position of page shift is added to the index data, and it is registered as such index data. When a document file is not included in the output file selected at Step S21 and audio format data is not created at Step S42, only the moving picture searching index is created. Likewise, in the following processes, the process for creating the audio searching index is not executed on the data when a document file is not included in the output file and audio or caption data is not created.

Next, at Step S48, the moving picture format data, which is selected as the output file or created by the conversion at Step S24, the audio format data created by the conversion at Step S42, and the caption data created by the conversion at Step S43 and S45 are converted into a data with a format conforming to applications for reproducing DVD (reproduced by a DVD reproducing unit). As such a format, for example, DVD-Video format can be employed.

Then, at Step S49, the data created at Step S48, the moving picture/audio searching index data created at step S47, and the data of output file selected at Step S21 are converted into logical format data to be written in on the DVD+RW media 3. As this logical format data, for example, UDF (8QLYHUVDO 'LVN) RUPDW) Ver.1.02 format can be employed. The output file to be converted by this process is the original data, retaining the state before the conversion into moving picture data at Step S24. The above Steps S49, S49 are the processes executed by the write-in data creation segment 15.

Afterward, at Step S28, the data created by the conversion at Step S49 are sent to the DVD+RW drive 2, which is driven to write in the data on the DVD+RW media 3 to finish the whole Steps. The data transmission segment 16 assumes the execution of this process, and the processes at Steps S48, S28 are included in the recording procedure. In the recording procedure, the main controller 122 and DVD+RW drive 2 operate as the recording means.

Therefore, the recording program 100 can make the PC 1 execute the process that, when the output file selected by a user is a document file or an image file, the output file is recorded in the DVD+RW media 3 as the moving picture data whose contents are displayed per page for a certain time. The information recording device for this embodiment can records the file selected by a user in the way described above, by executing the information recording method for this embodiment. Since the moving picture data mentioned above is recorded in the format that can be applicable to a reproduction using a DVD reproducing unit for commercial use, the DVD+RW media 3 having the data created by the above processes can be reproduced by the DVD reproducing unit in an environment without a computer, such as the PC 1, and the recorded contents can be visualized by displaying it on a proper display device, such as a television receiver.

The program 100 provides the same effects obtained by using the program, information recording method, and information recording method described in the first and third embodiments. Besides, according to the program, the text information constituting the document file included in the output file is converted into audio format data and is recorded, so that the contents of the output file can be reproduced by a DVD reproducing unit as sound, thus, made audible by using a proper speech device. Therefore, by using this program, an information recording medium with a high portability, capable of making the contents of the output file audible in an environment without a computer, can be created by a computer. Also, by using the information recording medium or information recording method for this embodiment, a similar information recording medium with a high portability can be created. Further, with the audio searching index also recorded, searching per one page content of the document file is possible, using the index, when the DVD reproducing unit is equipped with an interpreting mechanism for the index.

Also, by this program, the text information is converted into also caption data and recorded, so that, by displaying the caption data on a display device, the visibility of the contents of output file upon reproducing it on the reproducing unit can be improved. Further, the language of text information is translated into other language and the caption data of the other language is recorded, so that, for example, a DVD video with English caption can be easily created out of a document file described in Japanese. Thus, it is possible to create a recording medium, whose contents can be easily understood by a user living in a region where a language different from that of the original output file is used. The modification mentioned in the first embodiment can be also applied to the program, information recording device, and information recording method in the sixth embodiment.

In the translation at Step S44, the target language is not limited to one language, but may be a plurality of languages. For example, Japanese is translated into English and French, or other languages. In such a case, caption data is created for every target language. Though, in this description, an example is cited that all the conversion into audio format, into caption data, and into other language are made, the above conversions are not necessarily to be made in full, but may be made in an optional manner, in which each conversion process brings each effect without fail. When caption data is created for only one language, the data of the setting display is not necessarily to be made at Step S46. Also, creating the index is not imperative.

The program mentioned above may be pre-stored in a memory mean, such as ROM or hard disc, included in the PC 1 shown in FIG. 3, but may also be recorded, as in the cases of each embodiment described above, in a nonvolatile recording medium (memory) for application, or can be downloaded from a device connected to the PC 1 via a network.

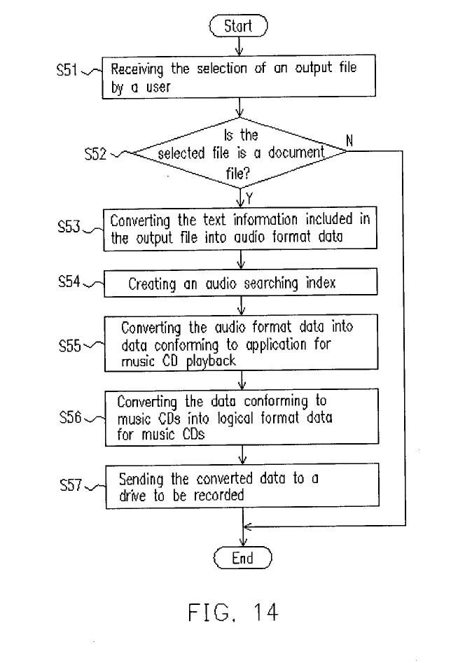

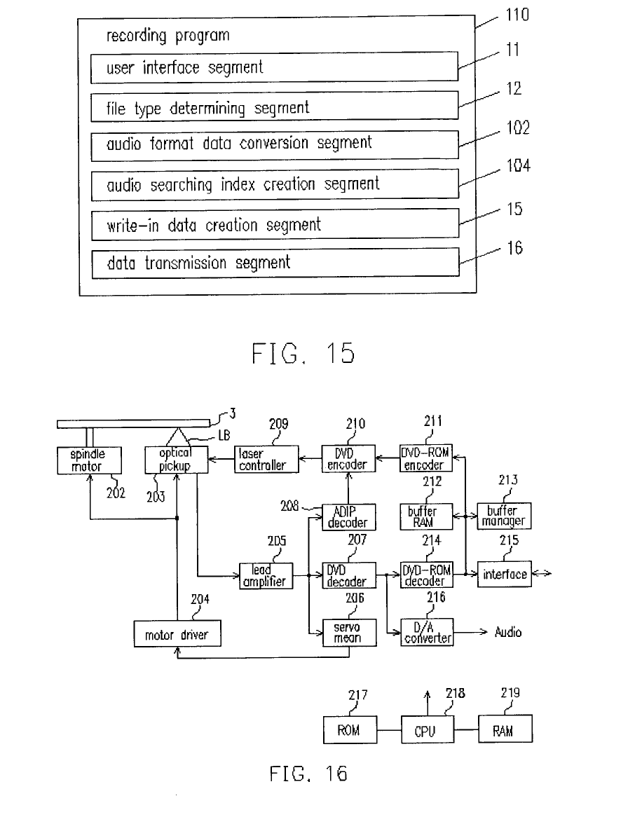

Seventh Embodiment: FIGS. 14 and 15

Next to be described is the seventh embodiment of the program, information recording device, and information recording method, all of which are disclosed in this invention. FIG. 14 is a flow chart showing the procedure of processes, which a computer executes by the program. FIG. 15 is a figure showing the constitution of the program. The program for this embodiment is a recording program, as the program for the first embodiment, by which a computer, such as a personal computer (PC), operates as respective means described below and executes procedures relating to the information recording method for this embodiment comprising respective procedures described below. In this description, however, different from the case of the first embodiment, the example is cited that the information recording device 200, as shown in FIG. 3, operates to make a disc-shape CD-R media, which is an information recording medium, execute recording, and the processes to be executed by this program is described.

In this embodiment, the information recording device 200 operates in such a way that the PC 1 controls the operation of DVD+RW drive 2 so that it can record or reproduce information on the disc-shape CD-R media.

This recording program 110, as shown in FIG. 15, comprises the user interface segment 11, the file type determining segment 12, the audio format data conversion segment 102, the audio searching index creation segment 104, the write-in data creation segment 15, and the data transmission segment 16. The program 110 is a device driver program for the PC 1 to control the DVD+RW drive 2.

When this recording program 110 is activated, the PC 1 comprising the information recording device 200 starts executing the operation related to the information recording method for this embodiment represented by the flow charts in FIG. 14. Since the processes of Steps S51 is the same as of Step S1 shown in FIG. 1 described in the first embodiment, further explanation is left out. At Step S52, whether the output file selected at Step S51 is a document file or not is determined. If it is not a document file, further processes cannot be executed, resulting in the end of the program. If it is a document file, the process proceeds to Step S53, where the text information included in the output file is converted into audio format data, as in the case of Step S42 shown in FIG. 11 described in the sixth embodiment. Then, at Step S54, the creation process of the audio searching index is executed, the index used for searching the contents of the sound represented by the audio format data converted at Step S53. The audio searching index creation segment 104 executes this process.

At following Step S55, the audio format data created by the conversion at Step S53 is converted into data with a format conforming to an application for music CD playback (playback by a music CD playback unit). As such a format, for example, CD-DA Compact Disc Digital Audio) can be employed. Then, at Step S56, the data converted at Step 55 and the audio searching index data created at Step 54 are converted into logical format data to be written in on the CD-R media. As this logical format, for example, such formats can be employed as ISO (Internation Organization for Standardization) 9660 format, UDF (Universal Disc Format)) Ver. 1.04 format, or UDF Ver. 1.5 format, etc. The write-in data creation segment 15 executes the above Steps S54, S55.

Afterward, at Step S56, the data created by the conversion at Step S55 is sent to the DVD+RW drive 2, which is driven to write in the data on the CD-R media to finish the whole Steps. The data transmission segment 16 assumes the execution of this process, and the processes at Steps S55, S57 are included in the recording procedure. In the recording procedure, the main controller 122 and DVD+RW drive 2 operate as the recording means.

Therefore, the recording program 110 can make the PC 1 execute the process that, when the output file selected by a user is a document file, the file is recorded in the CD-R media as the audio data for reading out the text information included in the document file. The information recording device for this embodiment can records the file selected by a user in the way described above, by executing the information recording method for this embodiment. Since the audio data mentioned above is recorded in the format that can be applicable to a playback using a music CD playback unit, the CD-R media having the data created by the above processes can be played back by the music playback unit in an environment without a computer, such as the PC 1, and the recorded contents can be made audible on a proper speech device, such as a speaker.

Further, with the audio searching index also recorded, searching per one page content of the document file is possible, using the index, when the CD playback unit is equipped with an interpreting mechanism for the index. Therefore, by using this program, an information recording medium with a high portability, capable of making the contents of the output file audible in an environment without a computer, can be created by a computer. Also, by using the information recording medium or information recording method for this embodiment, a similar information recording medium with a high portability can be created. If it is so arranged that the per-conversion output file is also recorded, as in the case of the first embodiment, a user is allowed to access the original output file to edit it when the user has a computer having a means for reading out from the information recording medium and an application for handling the output file stored in the information recording medium. In this case, the pre-conversion output file must be written in as a file formatted for data recording. Creating and recording the audio searching index is not an essential procedure, which can be omitted. Also, similar modifications, as in the case of the first embodiment, can be applied to this program.

The program mentioned above may be pre-stored in a memory mean, such as ROM or hard disc, included in the PC 1 shown in FIG. 3, but may also be recorded, as in the cases of each embodiment described above, in a nonvolatile recording medium (memory) for application, or can be downloaded from a device connected to the PC 1 via a network.

By the invented programs, as herein described above, a computer can create an information recording medium with a high portability, capable of visualizing and making audible the contents in the information recording medium in an environment without a computer. Also, according to the recording medium relating to this invention, the above information recording medium with a high portability can be created by making a computer without the above program store and execute the above program. Further, according to the invented information recording device and information recording method, the above information record medium with a high portability can be created.

While the present invention has been described with a preferred embodiment, this description is not intended to limit our invention. Various modifications of the embodiment will be apparent to those skilled in the art. It is therefore contemplated that the appended claims will cover any such modifications or embodiments as fall within the true scope of the invention.

What is claimed is:

1. A program for a computer to execute, comprising:
a selection receiving procedure, for receiving a selection of an output file from a user;
a moving picture creating procedure, for converting said output file into a moving picture format data to display contents of said output file per page when said output file selected in said selection receiving procedure is a document file or an image file; and
a recording procedure, for recording the moving picture format data converted in said moving picture creating procedure in an information recording medium.

2. The program of claim 1, wherein the moving picture creating procedure further comprises:
a procedure for creating a still image data for a print image of each page in an output file to be converted; and
a procedure for creating data for displaying a plurality of frames of said still data in series when the created still image data constitutes one frame.

3. The program of claim 2, further comprising a program for the computer to execute, comprising
a procedure for determining whether the output file selected in the selection receiving procedure is a moving picture file that records the moving picture format data; and
a procedure for recording said output file directly in the information recording medium when the computer determines in said determining procedure that said output file is the moving picture file.

4. The program of claim 3, further comprising a program for the computer to execute, comprising:
a procedure for creating a moving picture searching index for searching contents of moving pictures created by the moving picture format data; and
a procedure for recording the moving picture searching index created in said procedure in the information recording medium.

5. The program of claim 4, further comprising a program for the computer to execute, by which, in the recording procedure, said output file of pre-conversion state is also recorded in the information recording medium when the moving picture format data converted in the moving picture creating procedure is recorded in said information recording medium.

6. A program for a computer to execute, comprising:
a selection receiving procedure, for receiving a selection of an output file from a user and an output destination of said output file;
a moving picture creating procedure, for converting said output file into a moving picture format data to display contents of said output file per page when an information recording medium is selected as the output destination in said selection receiving procedure and said output file selected in said selection receiving procedure is a document file or an image file; and
a recording procedure, for recording the moving picture format data converted in said moving picture creating procedure in the information recording medium.

7. The program of claim 6, wherein the moving picture creating procedure further comprises:
a procedure for creating a still image data for a print image of each page in an output file to be converted; and
a procedure for creating data for displaying a plurality of frames of said still data in series when the created still image data constitutes one frame.

8. The program of claims 7, further comprising a program for the computer to execute, comprising
a procedure for determining whether the output file selected in the selection receiving procedure is a moving picture file that records the moving picture format data; and
a procedure for recording said output file directly in the information recording medium when the computer determines in said determining procedure that said output file is the moving picture file.

9. The program of claims 8, further comprising a program for the computer to execute, comprising:
a procedure for creating a moving picture searching index for searching contents of moving pictures created by the moving picture format data; and
a procedure for recording the moving picture searching index created in said procedure in the information recording medium.

10. The program of claim 9, further comprising a program for the computer to execute, by which, in the recording procedure, said output file of pre-conversion state is also recorded in the information recording medium when the moving picture format data converted in the moving picture creating procedure is recorded in said information recording medium.

11. A program for a computer to execute, comprising:
a selection receiving procedure for receiving a selection of an output file from a user;
a moving picture creating procedure for receiving a specified displaying time for each page of said output file to convert contents of said output file into contents of the moving picture format data that are displayed by the displaying time specified by each page, when the selected output file is a document file or an image file; and
a recording procedure for recording the moving picture format data converted in said procedure in an information recording medium.

12. A program for a computer to execute, comprising:
a selection receiving procedure for receiving a selection of an output file from a user;
a moving picture creating procedure for converting said output file into a moving picture format data to display contents of said output file per page when said output file selected in said selection receiving procedure is a document file or an image file;
a chapter grouping procedure, for setting a chapter grouping for the moving picture format data converted in said moving picture creating procedure, so that the display of the output data per one page or a series of multiple pages are grouped into a chapter; and
a recording procedure for recording the moving picture format data in an information recording medium after setting the chapter grouping in said chapter grouping procedure.

13. A program for a computer to execute, comprising:
a selection receiving procedure for receiving a selection of an output file and an destination of said output file from a user,
a moving picture creating procedure for receiving a specified displaying time for each page of said output file to convert contents of said output file into contents of the moving picture format data that are displayed by the displaying time specified by each page, when an information recording medium is selected as the output destination in said selection receiving procedure and the selected output file is a document file or an image file; and
a recording procedure, for recording the moving picture format data converted in said moving picture creating procedure in the information recording medium.

14. A program for a computer to execute, comprising:
a selection receiving procedure, for receiving a selection of an output file and an output destination of said output file from a user,
a moving picture creating procedure, for converting said output file into a moving picture format data to display contents of said output file per page when an information recording medium is selected as the output destination in said selection receiving procedure and the selected output file is a document file or image file;
a chapter grouping procedure, for setting a chapter grouping for the moving picture format data converted in said moving picture creating procedure so that the display of the output data per one page or a series of multiple pages are grouped into a chapter, and
a recording procedure for recording the moving picture format data in the information recording medium after setting the chapter grouping in said chapter grouping procedure.

15. A program for a computer to execute, comprising
a selection receiving procedure, for receiving a selection of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
an audio creating procedure, for converting a text information included in the document file into an audio format data when the selected output file is the document file; and
a recording procedure, for recording the moving picture format data converted in the moving picture creating procedure and the audio format data converted in the audio creating procedure in an information recording medium.

16. A program for a computer to execute, comprising:
a selection receiving procedure, for receiving a election of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
a caption creating procedure, for converting a text information included in the document file into a caption data when the selected output file is the document file; and
a recording procedure, for recording the moving picture format data converted in the moving picture creating procedure and the caption data converted in the caption creating procedure in an information recording medium.

17. A program for a computer to execute, comprising:
a selection receiving procedure, for receiving a selection of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
a first caption creating procedure, for converting a text information included in the document file into a first caption data when the selected output file is the document file;
a second caption creating procedure, for translating the text file from a source language into another language and converting the translated text information into a second caption data,
a setting display creating procedure, for creating a setting display data for selecting a language used in the caption; and
a recording procedure, for recording the moving picture format data converted in the moving picture creating procedure, the first and the second caption data respectively converted in the first and second caption creating procedures, and the setting display data created in the setting display creating procedure in an information recording medium.

18. A program for a computer to execute, comprising:
a selection receiving procedure for receiving a selection of an output file from a user;
an audio creating procedure, for converting a text information included in the document file an into audio format data when the selected output file is the document file; and
a recording procedure, for recording the audio format data converted in said audio creating procedure in an information recording medium in a music reproducing format.

19. The program of claim 15, further comprising a program for the computer to execute a procedure for creating an audio searching index for searching audio contents provided by the audio format data, and a procedure for recording the audio searching index created in said procedure in the information recording medium.

20. The program of claim 18, further comprising a program for the computer to execute a procedure for creating an audio searching index for searching audio contents provided by the audio format data, and a procedure for recording the audio searching index created in said procedure in the information recording medium.

21. The program of claim 19, in which the above mentioned recording procedure further comprises a procedure for recording also said output file of pre-conversion state in an information recording medium when the audio format data converted in the above mentioned audio creating procedure is recorded in said information recording medium.

22. The program of claim 20, in which the above mentioned recording procedure further comprises a procedure for recording also said output file of pre-conversion state in an information recording medium when the audio format data converted in the above mentioned audio creating procedure is recorded in said information recording medium.

23. An information recording device, comprising:
a selection receiving means for receiving a selection of an output file from a user;
a moving picture creating means for converting said output file into a moving picture format data to display contents of said output file per page when said output file selected by said selection receiving means is a document file or an image file; and
a recording means for recording the moving picture format data converted by said moving picture creating means in an information recording medium.

24. An information recording device, comprising:
a selection receiving means for receiving a selection of an output file and an output destination of said output file from a user;
a moving picture creating means for converting said output file into a moving picture format data to display contents of said output file per page when the output destination received as the selection by said selection receiving means is an information recording medium and said output file received as the selection by said selection receiving means is a document file or an image file; and
a recording means for recording the moving picture format data converted by said moving picture creating means in the information recording medium.

25. An information recording device, comprising:
a selection receiving means for receiving a selection of an output file from a user;
a moving picture creating means for receiving a specified displaying time for each page of said output file to convert contents of said output file received as the selection by said moving picture creating means into contents of the moving picture format data that are displayed by the displaying time specified by each page, when the selected output file is a document file or an image file; and
a recording means for recording the moving picture format data converted by said moving picture creating means in an information recording medium.

26. An information recording device, comprising:
a selection receiving means for receiving a selection of an output file from a user;
a moving picture creating means for converting said output file into a moving picture format data to display contents of said output file per page when the output file, received as the selection by said selection receiving means is a document file or an image file;
a chapter grouping means for setting a chapter grouping for the moving picture format data converted by said moving picture creating means so that a display of the output data per page or a series of multiple pages are grouped into a chapter; and
a recording means for recording the moving picture format data in an information recording medium after the chapter grouping is set by said chapter grouping means.

27. An information recording device, comprising:
a selection receiving means for receiving a selection of an output file and an output destination of said output file from a user;
a moving picture creating means for receiving a specified displaying time for each page of said output file to convert contents of said output file received as the selection by said moving picture creating means into contents of the moving picture format data that are displayed by the displaying time specified by each page, when the output destination received as the selection by said selection receiving means is an information recording medium and said output file received as the selection by said selection receiving means is a document file or an image file; and
a recording means for recording the moving picture format data converted by said moving picture creating means in the information recording medium.

28. An information recording device, comprising:
a selection receiving means for receiving a selection of an output file and an output destination of said output file from a user;
a moving picture creating means for converting said output file into a moving picture format data to display contents of said output file per page when the output destination received as the selection by said selection receiving means is an information recording medium and said output file received as the selection by said selection receiving means is a document file or an image file;
a chapter grouping means for setting a chapter grouping for the moving picture format data converted by said moving picture creating means so that a display of the output file per one page or a series of multiple pages are grouped into a chapter; and
a recording means for recording the moving picture format data in the information recording medium after the chapter grouping is set by said chapter grouping means.

29. An information recording device, comprising:
a selection receiving means for receiving a selection of an output file from a user;
a moving picture creating means for receiving a specified displaying time for each page of said output file to convert contents of said output file received as the selection by said moving picture creating means into contents of the moving picture format data that are displayed by the displaying time specified by each page, when said output file received as the selection by said selection receiving means is a document file or an image file;
an audio creating means for converting a text information contained in the document file into an audio format data when the selected output file is the document file; and
a recording means for recording the moving picture format data converted by the moving picture creating means and the audio format data converted by the audio creating means in an information recording medium.

30. An information recording device, comprising:
a selection receiving means for receiving a selection of an output file from a user;
a moving picture creating means for receiving a specified displaying time for each page of said output file to convert contents of said output file received as the selection by said moving picture creating means into contents of the moving picture format data that are displayed by the displaying time specified by each page when said output file received as the selection by said selection receiving means is a document file or an image file;
a caption creating means for converting a text information included in the document file into a caption data when the selected output file is the document file; and
a recording means for recording the moving picture format data converted by the moving picture creating means and the caption data converted by the caption creating means in an information recording medium.

31. An information recording device, comprising:
a selection receiving means for receiving a selection of an output file from a user;
a moving picture creating means for receiving a specified displaying time for each page of said output file to convert contents of said output file received as the selection by said moving picture creating means into contents of the moving picture format data that are displayed by the displaying time specified by each page when said output file received as the selection by said selection receiving means is a document file or an image file;
a first caption creating means for converting a text information included in the document file into a first caption data when the selected output file is the document file;
a second caption creating means for translating the document file from a source language into another language and converting the translated text information into a second caption data;
a setting display creating means for creating a setting display data for selecting a language used in the caption; and
a recording means for recording the moving picture format data converted by the moving picture creating means, the first and the second caption data respectively converted by the first and second caption creating means, and the setting display data created by the setting display creating means in an information recording medium.

32. An information recording device, comprising:
a selection receiving means for receiving a selection of an output file from a user;
an audio creating means for converting a text information contained in a document file into an audio format data when the output file received as the selection by said selection receiving means is the document file; and
a recording means for recording the audio format data converted by said audio creating means in an information recording medium in a music reproducing format.

33. An information recording method, comprising receiving a selection of an output file from a user;
converting said output file into a moving picture format data to display contents of said output file per page when the selected output file is a document file or an image file; and
recording the moving picture format data converted in said converting procedure in an information recording medium.

34. An information recording method, comprising
receiving a selection of an output file and an output destination of said output file from a user;
converting said output file into a moving picture format data to display contents of said output file per page when an information recording medium is selected as the output destination in said receiving procedure and the output file selected in said receiving procedure is a document file or an image file; and
recording the moving picture format data converted in said converting procedure in the information recording medium.

35. An information recording method, comprising
receiving a selection of an output file from a user;
receiving a specified displaying time for each page of said output file to convert contents of said output file received as the selection by said moving picture creating means into contents of the moving picture format data that are displayed by the displaying time specified by each page, when the selected output file is a document file or an image file; and
recording the converted moving picture format data in an information recording medium.

36. An information recording method, comprising
receiving a selection of an output file from a user,
converting said output file into a moving picture format data to display contents of said output file per page when said selected output file e is a document file or an image file;
setting a chapter grouping for the moving picture format data converted in said converting procedure so that a display of the output file per page or a series of multiple pages are grouped into a chapter; and
recording the moving picture format data in an information recording medium after the chapter grouping is setting in said chapter grouping procedure.

37. An information recording method, comprising
receiving a selection of an output file and an output destination of said output file from a user;
receiving a specified displaying time for each page of said output file to convert contents of said output file received as the selection by said moving picture creating means into contents of the moving picture format data that are displayed by the displaying time specified by each page, when an information recording medium is selected as the output destination in said receiving procedure and the selected output file is a document file or an image file; and
recording the converted moving picture format data in said procedure in the information recording medium.

38. An information recording method, comprising
receiving a selection of an output file and an output destination of said output file from a user;
receiving a specified displaying time for each page of said output file to convert contents of said output file received as the selection by said moving picture creating means into contents of the moving picture format data that are displayed by the displaying time specified by each page, when an information recording medium is selected as the output destination in said procedure and the output file selected in said procedure is a document file or an image file;
setting a chapter grouping for the moving picture format data converted in said procedure so that the display of the output data per page or a series of multiple pages are grouped into a chapter; and
recording the moving picture format data in the information recording medium after the chapter grouping is set in said chapter grouping procedure.

39. An information recording method, comprising:
receiving a selection of an output file from a user;
receiving a specified displaying time for each page of said output file to convert contents of said output file received as the selection by said moving picture creating means into contents of the moving picture format data that are displayed by the displaying time specified by each page, when the selected output file is a document file or an image file;
converting a text information contained in the document file into an audio format data when the selected output file is the document file; and
recording the converted moving picture format data creating procedure and the converted audio format data creating procedure in an information recording medium,.

40. An information recording method, comprising:
receiving a selection of an output file from a user
receiving a specified displaying time for each page of said output file to convert contents of said output file received as the selection by said moving picture creating means into contents of the moving picture format data that are displayed by the displaying time specified by each page, when the selected output file is a document file or an image file;
converting a text information contained in the document file into caption data when the selected output file is the document file; and
recording the converted moving picture format data creating procedure and the caption data creating procedure in an information recording medium,.

41. An information recording method, comprising
receiving a selection of an output file from a user;
receiving a specified displaying time for each page of said output file to convert contents of said output file received as the selection by said moving picture creating means into contents of the moving picture format data that are displayed by the displaying time specified by each page, when the selected output file is a document file or an image file;
converting a text information contained in the document file into a first caption data when the selected output file is the document file;
translating the document file from a source language into another language and converting the translated text information into a second caption data;
creating a setting display data for selecting a language used in the caption; and
recording the converted moving picture format data creating procedure, the first and the second caption data creating procedure, and the setting display data creating procedure in an information recording medium,.

42. An information recording method, comprising
receiving a selection of an output file from a user;
converting a text information contained in a document file into an audio format data when the selected output file is a document file, and
for recording the audio format data in an information recording medium in a music reproducing format for music.

43. A computer-readable recording medium, a program being recorded therein, the program for a computer to execute, comprising:
a selection receiving procedure, for receiving a selection of an output file from a user;
a moving picture creating procedure, for converting said output file into a moving picture format data to display contents of said output file per page when said output file selected in said selection receiving procedure is a document file or an image file; and
a recording procedure, for recording the moving picture format data converted in said moving picture creating procedure in an information recording medium.

44. The computer-readable recording medium, wherein the selection receiving procedure further comprises a step for receiving an output destination of said output file, and the moving picture creating procedure is performed when an information recording medium is selected as the output destination in said selection receiving procedure.

45. The computer-readable recording medium of claim 44, wherein the moving picture creating procedure further comprises:
a procedure for creating a still image data for a print image of each page in an output file to be converted; and
a procedure for creating data for displaying a plurality of frames of said still data in series when the created still image data constitutes one frame.

46. The computer-readable recording medium of claim 45, further comprising a program for the computer to execute, comprising
a procedure for determining whether the output file selected in the selection receiving procedure is a moving picture file that records the moving picture format data; and
a procedure for recording said output file directly in the information recording medium when the computer determines in said determining procedure that said output file is the moving picture file.

47. The computer-readable recording medium of claims 46, further comprising a program for the computer to execute, comprising:
a procedure for creating a moving picture searching index for searching contents of moving pictures created by the moving picture format data; and
a procedure for recording the moving picture searching index created in said procedure in the information recording medium.

48. The program of claim 47, further comprising a program for the computer to execute, by which, in the recording procedure, said output file of pre-conversion state is also recorded in the information recording medium when the moving picture format data converted in the moving picture creating procedure is recorded in said information recording medium.

49. A computer-readable recording medium, a program being recorded therein, the program for a computer to execute, comprising:
a selection receiving procedure for receiving a selection of an output file from a user;
a moving picture creating procedure for receiving a specified displaying time for each page of said output file to convert contents of said output file into contents of the moving picture format data that are displayed by the displaying time specified by each page, when the selected output file is a document file or an image file; and
a recording procedure for recording the moving picture format data converted in said procedure in an information recording medium.

50. A computer-readable recording medium, a program being recorded therein, the program for a computer to execute, comprising:
a selection receiving procedure for receiving a selection of an output file from a user;
a moving picture creating procedure for converting said output file into a moving picture format data to display contents of said output file per page when said output file selected in said selection receiving procedure is a document file or an image file;
a chapter grouping procedure, for setting a chapter grouping for the moving picture format data converted in said moving picture creating procedure, so that the display of the output data per one page or a series of multiple pages are grouped into a chapter; and
a recording procedure for recording the moving picture format data in an information recording medium after setting the chapter grouping in said chapter grouping procedure.

51. A computer-readable recording medium, a program being recorded therein, the program for a computer to execute, comprising:
a selection receiving procedure for receiving a selection of an output file and an destination of said output file from a user,
a moving picture creating procedure for receiving a specified displaying time for each page of said output file to convert contents of said output file into contents of the moving picture format data that are displayed by the displaying time specified by each page, when an information recording medium is selected as the output destination in said selection receiving procedure and the selected output file is a document file or an image file; and
a recording procedure, for recording the moving picture format data converted in said moving picture creating procedure in the information recording medium.

52. A computer-readable recording medium, a program being recorded therein, the program for a computer to execute, comprising:
a selection receiving procedure, for receiving a selection of an output file and an output destination of said output file from a user,
a moving picture creating procedure, for converting said output file into a moving picture format data to display contents of said output file per page when an information recording medium is selected as the output destination in said selection receiving procedure and the selected output file is a document file or image file;
a chapter grouping procedure, for setting a chapter grouping for the moving picture format data converted in said moving picture creating procedure so that the display of the output data per one page or a series of multiple pages are grouped into a chapter, and
a recording procedure for recording the moving picture format data in the information recording medium after setting the chapter grouping in said chapter grouping procedure.

53. A computer-readable recording medium, a program being recorded therein, the program for a computer to execute, comprising:
a selection receiving procedure, for receiving a selection of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
an audio creating procedure, for converting a text information included in the document file into an audio format data when the selected output file is the document file; and
a recording procedure, for recording the moving picture format data converted in the moving picture creating procedure and the audio format data converted in the audio creating procedure in an information recording medium.

54. A computer-readable recording medium, a program being recorded therein, the program for a computer to execute, comprising:
a selection receiving procedure, for receiving a election of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
a caption creating procedure, for converting a text information included in the document file into a caption data when the selected output file is the document file; and
a recording procedure, for recording the moving picture format data converted in the moving picture creating procedure and the caption data converted in the caption creating procedure in an information recording medium.

55. A computer-readable recording medium, a program being recorded therein, the program for a computer to execute, comprising:
a selection receiving procedure, for receiving a selection of an output file from a user;
a moving picture creating procedure, for receiving a specified displaying time for each page of said output file to convert contents of said output file into contents of the moving picture format data that are displayed by the displaying time specified by each page, when the selected output file is a document file or an image file;
a first caption creating procedure, for converting a text information included in the document file into a first caption data when the selected output file is the document file;
a second caption creating procedure, for translating the text file from a source language into another language and converting the translated text information into a second caption data,
a setting display creating procedure, for creating a setting display data for selecting a language used in the caption; and
a recording procedure, for recording the moving picture format data converted in the moving picture creating procedure, the first and the second caption data respectively converted in the first and second caption creating procedures, and the setting display data created in the setting display creating procedure in an information recording medium.

56. A computer-readable recording medium, a program being recorded therein, the program for a computer to execute, comprising:
a selection receiving procedure for receiving a selection of an output file from a user;
an audio creating procedure, for converting a text information included in the document file an into audio format data when the selected output file is the document file; and
a recording procedure, for recording the audio format data converted in said audio creating procedure in an information recording medium in a music reproducing format.

57. The program of claim 53, further comprising a program for the computer to execute a procedure for creating an audio searching index for searching audio contents provided by the audio format data, and a procedure for recording the audio searching index created in said procedure in the information recording medium.

58. The program of claim 56, further comprising a program for the computer to execute a procedure for creating an audio searching index for searching audio contents provided by the audio format data, and a procedure for recording the audio searching index created in said procedure in the information recording medium.

59. The program of claim 53, in which the above mentioned recording procedure further comprises a procedure for recording also said output file of pre-conversion state in an information recording medium when the audio format data converted in the above mentioned audio creating procedure is recorded in said information recording medium.

60. The program of claim 56, in which the above mentioned recording procedure further comprises a procedure for recording also said output file of pre-conversion state in an information recording medium when the audio format data converted in the above mentioned audio creating procedure is recorded in said information recording medium.

61. The program of claim 57, in which the above mentioned recording procedure further comprises a procedure for recording also said output file of pre-conversion state in an information recording medium when the audio format data converted in the above mentioned audio creating procedure is recorded in said information recording medium.
